(19) United States
(12) Patent Application Publication
(10) Pub. No.: US 2023/0121307 A1
(43) Pub. Date: Apr. 20, 2023

(54) VIRTUAL LOBBY FOR SOCIAL EXPERIENCES

(71) Applicant: AMI Holdings Limited, Hamilton (BM)

(72) Inventors: Ronen Benchetrit, London (GB); Tariq Masud Shaukat, Austin, TX (US); Stefan Marinov Markov, Hamilton (BM)

(21) Appl. No.: 17/965,364

(22) Filed: Oct. 13, 2022

Related U.S. Application Data
(60) Provisional application No. 63/256,715, filed on Oct. 18, 2021.

(51) Int. Cl. H04N 7/15; G06Q 50/00

(52) U.S. Cl. CPC H04N 7/157; G06Q 50/01

(57) ABSTRACT

Methods, systems, and apparatus, including computer programs encoded on computer storage media, for enabling a virtual lobby. In some implementations, a server receives a request from a first client device to enter a function of a virtual lobby. The server generates a pre-selected number of users to include in the function of the virtual lobby based on a plurality of client devices that opted into the function. The server provides data to each of the pre-selected number of users to indicate an acceptance into the function. The server generates a first communication channel between the first client device and a second client device, wherein the communication channel ensures other users cannot access communications between the first and the second client device. In response to closing the first communication channel, the server generates a second communication channel between the first and the second client device outside the virtual lobby.

### CROSS-REFERENCE TO RELATED APPLICATION

This application claims the benefit of U.S. Provisional Application No. 63/256,715 filed Oct. 18, 2021, and titled “Virtual Lobby for Social Experiences,” which is incorporated herein by reference in its entirety.

### TECHNICAL FIELD

This specification generally relates to social networking applications, and more specifically, social networking applications deployed in computer networks.

### BACKGROUND

Social networking applications enable individuals to match to other individuals with a goal of developing a personal, romantic, or professional relationship. After two individuals connect in a match, the matched individuals may communicate with one another electronically using the social networking application.

### SUMMARY

The techniques described in this specification enable users in a social networking environment to match to other individuals. In some implementations, each user using the social network can generate a profile that characterizes that user. The profile can illustrate a name of the user, photos of the user, their interests, location, and/or other characteristics that represent the user. In some implementations, a user of the social networking environment can view profiles of other users. This user may be referred to as the “requesting user.” In response to reviewing the profiles of other users, the requesting user can request a match with one or more other users. The one or more other users may be referred to as the “reviewing users.” Additionally or alternatively, the reviewing user or users may view the profile of the requesting user and in response, decide to match with the requesting user. A selection engine, situated between client devices associated with the requesting user and the reviewing user(s), can receive the request to match from one or both client devices and can facilitate network communications between these two users. In response, the two users can communicate with one another in the social network environment over the network communications.

In some implementations, the social network environment can provide enhanced communication functionalities for various users seeking to connect and communicate with potential matches. The social network environment can provide users with a virtual lobby, for example, that offers different communication mediums by which users can explore potential matches. For example, the virtual lobby can enable users to explore potential matches using (i) a speed dating audio function, (ii) a singles evening function, and (iii) a live streaming function. Additionally, the virtual lobby can indicate that users can exit the virtual lobby and return to regular matchmaking. Additionally, the social networking applications described in this specification can relate to scenarios that include, for example, dating, professional recruiting and networking, as well as interest-based discussion.

The speed dating audio function in the social networking environment can enable a user to be matched with another user based on characteristics of both users. For example, the speed dating option can assign two users who are participating in the virtual lobby to match with one another randomly using characteristics shared between both users. Alternatively, a user can request to open an audio channel with another user in the virtual lobby. The matched users can then be assigned an audio only session or channel for communicating for a predetermined amount of time. The matched users can audibly communicate with one another in the channel. In some implementations, the social networking environment can convert the audible communications between the matched users to various gestures, reactions, emoji’s, and/or other audible annotations. For example as the users communicate over the audio channel, the social networking environment can convert words or phrases of the audible communications to annotations that are displayed on the client devices of both matched users. After the predetermined amount of time has elapsed, the two matched users can decide to return to the virtual lobby or can continue the conversation outside the virtual lobby in a private chatroom.

The singles evening function in the social networking environment can enable a user to interact and communicate in a social environment. For example, when a particular user enters the virtual lobby and selects the single evening function, the social networking environment can pre-select other users to join the virtual lobby of the singles evening based on similar criteria of the users. In some implementations, the users within the virtual lobby of the singles evening can communicate collectively with one another. For example, if the virtual lobby contains eight users, each of the eight users can communicate with one another, such that each user can hear the voices of each of the other users. Additionally or alternatively, a requesting user within the virtual lobby can send a direct message or a “whisper” to a reviewing user within the virtual lobby. When a whisper is performed, only the requesting and reviewing users can hear one another and the other six users in the virtual lobby cannot. Moreover, the requesting user and the reviewing user within the private whisper can hear conversation of other users outside of the whisper function, e.g., in the background of their “whisper” conversation, but the other users outside of the whisper conversation cannot hear the conversation between the requesting and reviewing users. At the end of the whisper function, the requesting user and the reviewing user can end the whisper conversation and return to the virtual lobby or decide to carry on a conversation outside the virtual lobby in a private chatroom.

The live streaming function enables users to connect using a discovery channel on a social media application. In particular, a first user can request to initiate a live communication or live streaming to a plurality of other users. One or more of the other users can request to join the live streaming initiated by the user. In response, a system can present the live streaming to the client devices associated with those other users. During the live communication, the client device associated with the first user can receive a vote from a second user to match with the first user, where the second user is one of the users who has joined the live streaming. In response to the client device associated with the first user receiving the vote, the system can terminate the live streaming and enable a one-to-one communication channel between the first user and the second user.

In one general aspect, a method performed by a server includes: receiving, by a server, a request from a first client device associated with a first user to enter a function of a virtual lobby; generating, by the server, a pre-selected number of users to include in the function of the virtual lobby based on a plurality of client devices that opted into the function of the virtual lobby; providing, by the server, data to each of the client devices corresponding to the pre-selected number of users to indicate an acceptance into the function of the virtual lobby; generating, by a the server, a first communication channel between the first client device and a second client device from the plurality of client devices associated with the pre-selected number of users, wherein the communication channel ensures other users accepted into the virtual lobby cannot access communications between the first client device and the second client device in the first communications channel; and in response to a closing of the first communication channel, generating, by the server, a second communication channel between the first client device and the second client device outside the virtual lobby.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the function of the virtual lobby includes one or more of (i) a speed dating audio function, (ii) a singles evening function, or (iii) a live streaming function.

In some implementations, generating the pre-selected number of users to include in the function of the virtual lobby based on the plurality of client devices that opted into the function of the virtual lobby further includes: receiving, by the server, multiple requests from the plurality of client devices to enter the speed dating audio function, the singles evening function, or the live streaming function; generating, by the server, a first group from the plurality of client devices to enter a first virtual lobby of the speed dating audio function; generating, by the server, a second group from the plurality of client devices to enter a second virtual lobby of the singles evening function; and generating, by the server, a third group from the plurality of client devices to enter a third virtual lobby of the live streaming function, wherein the users associated with the first group, the users associated with the second group, and the users associated with the third group are each different.

In some implementations, the method includes generating, by the server, (i) one or more clusters within the first group, (ii) one or more clusters within the second group, and (iii) one or more clusters within the third group, wherein the server generates the one or more clusters for each group based on criteria associated with each of the clusters.

In some implementations, providing the data to each of the client devices corresponding to the pre-selected numbers to indicate the acceptance into the function of the virtual lobby further includes: providing, by the server, first data to each of the client devices associated with the first group indicating the acceptance into the first virtual lobby of the speed dating audio function; providing, by the server, second data to each of the client devices associated with the second group indicating the acceptance into the second virtual lobby of the singles evening function; and providing, by the server, third data to each of the client devices associated with the third group indicating the acceptance into the third virtual lobby of the live streaming function.

In some implementations, generating the first communication channel between the first client device and a second client device from the plurality of client devices associated with the pre-selected number of users further includes: generating, by the server, the first communication channel between the first client device and the second client device from the plurality of client devices in the speed dating audio function, wherein the first communication channel is assigned based on a random match between the first client device and the second client device; and in response to the closing of the first communication channel after an amount of time has elapsed during communications of the first communication channel, generating, by the server, a second communication channel between the first client device and a third client device from the plurality of client devices in the speed dating audio function.

In some implementations, the first user associated with the first client device and a second user of the second client device communicate over the first communication channel using audio communications, the method further includes: receiving, by the server, the audio communications from the first client device through the first communication channel; and providing, by the server, the audio communications from the first client device through the first communication channel to the second client device.

In some implementations, the method includes: in response to receiving the audio communications from the first client device, generating, by the server, audible annotations from portions of the received audio communications; and providing, by the server, the generated audible annotations from portions of the received audio communications, to the second client device.

In some implementations, generating the first communication channel between the first client device and a second client device from the plurality of client devices associated with the pre-selected number of users further includes: receiving, by the server, a request from the first client device to communicate with the second client device within the virtual lobby; generating, by the server, the first communication channel between the first client device and the second client device within the virtual lobby, wherein the first communication channel ensures (i) the other users accepted into the virtual lobby cannot access subsequent communications between the first client device and the second client device for a predefined period of time and (ii) the first client device and the second client device have access to other subsequent communications between other client devices within the virtual lobby while the respective users are accessing the virtual lobby; providing, by the server, the request from the first client device to communicate with the second client device to the second client device; and receiving, by the server, an acceptance from the second client device indicating the second client device accepts the request to communicate with the first client device over the first communication channel.

In some implementations, generating the first communication channel between the first client device and the second client device within the virtual lobby further includes: generating, by the server, the first communication channel between the first client device and the second client device within the virtual lobby, wherein the first user associated with the first client device and the second user associated with the second client device communicate within a private audio conversation over the first communication channel.

In some implementations, the first user and the second user hear audio conversation from other users associated with the other client devices within the virtual lobby at a low-level volume.

In some implementations, in response to the closing of the first communication channel, generating the second communication channel between the first client device and the second client device outside the virtual lobby further comprises: receiving, by the server, a request from the second client device that they request to continue a conversation with the first client device out the virtual lobby; and generating, by the server, the second communication channel between the first client device and the second client device outside the function of the virtual lobby.

In one general aspect, a method performed by a server includes: receiving, by a server, a request from a first client device associated with a first user to enter a speed dating function of a virtual lobby; generating, by the server, a pre-selected number of users to include in the speed dating function of the virtual lobby based on a plurality of client devices that opted into the speed dating function of the virtual lobby; providing, by the server, data to each of the client devices corresponding to the pre-selected number of users to indicate an acceptance into the speed dating function of the virtual lobby; generating, by the server, a first communication channel between the first client device and a second client device from the plurality of client devices associated with the pre-selected number of users, wherein the generated first communication channel is based on shared similarities between the first user and a second user associated with the second client device; managing, by the server, communications over the first communication channel between the first client device and the second client device for a predetermined amount of time; in response to the predetermined amount of time elapsing, closing, by the server, the first communications channel; and generating, by the server, a second communication channel between the first client device and a third client device from the plurality of client device associated with the pre-selected number of users.

In one general aspect, a method performed by a server includes: receiving, by a server, a request from a first client device associated with a first user to enter a singles evening function of a virtual lobby; generating, by the server, a pre-selected number of users to include in the singles evening function of the virtual lobby based on a plurality of client devices that opted into the singles evening function of the virtual lobby; providing, by the server, data to each of the client devices corresponding to the pre-selected number of users to indicate an acceptance into the singles evening function of the virtual lobby; receiving, by the server, a whisper request from the first client device, the whisper request indicating a request to open a communications channel between the first client device and a second client device; providing, by the server, the whisper request to the second client device; receiving, by the server, an acceptance from the second client device to initiate the whisper request; in response to receiving the acceptance, generating, by the server, a first communications channel between the first client device and the second client device; and managing, by the server, first communications over the first communications channel between the first client device and the second client device, wherein the first communications channel enables (i) the first client device and the second client device to access second communications within the virtual lobby from other client devices, (ii) the first client device and the second client device can access the first communications, and (iii) blocks the other client devices within the virtual lobby from accessing the first communications.

In one general aspect, a method performed by a server for identifying a match between a first user and a second user, wherein the first user and the second user are users of a social network, the method includes: receiving, from a first client device associated with the first user, a request to initiate a live communication to a plurality of users of the social network; in response to the request to initiate the live communication, providing data indicative of the live communication to the plurality of users of the social network, wherein the plurality of users include the second user; receiving, from a second client device associated with the second user, a request to join the live communication; in response to the request to join the live communication, causing presentation of the live communication at the second client device; receiving, from the second client device, a vote to match with the first user; receiving, from the first client device, a vote to match with the second user; in response to the votes by the first user and the second user: terminating the live communication; and enabling a one-to-one communication channel between the first user and the second user.

In some implementations, the live communication is a real time transmission from the first client device to the second client device through a server of the social network.

In some implementations, causing presentation of the live communication includes causing transmission of one or more of audio data and video data.

In some implementations, providing the data indicative of the live communication includes providing a feed of available live communications to the second client device, the feed including the live communication.

In some implementations, the method includes: identifying a number of users who voted to match with the first user; determining that the number of users who voted to match with the first user exceeds a pre-defined threshold of a maximum number of votes to match with the first user; and in response to determining that the number of users who voted to match with the first user exceeds the pre-defined threshold, causing presentation of the live communication at a client device associated with at least one of the plurality of users without an option to express a vote to match with the first user.

In some implementations, enabling the one-to-one communication channel between the first user and the second user includes enabling transmission of one or more of audio data and video data between the first client device and the second client device.

In some implementations, terminating the live communication includes enabling display indicative of information that a match is established to the first client device associated with the first user and the second client device associated with the second user.

In some implementations, the method includes: determining that the live communication includes a forbidden content topic; and terminating the live communication that includes the forbidden content topic.

In some implementations, receiving the request to initiate the live communication includes receiving a request from the first client device to enter a live streaming function of a virtual lobby.

In some implementations, receiving the request to join the live communication includes receiving a request from the second client device to enter a live streaming function of a virtual lobby.

In some implementations, providing the feed of available live communications includes organizing the feed of available live communications on a display of the second client device based on an initiation time of each of the available live communications.

In some implementations, providing the feed of available live communications includes presenting, on a display of the second client device, a subset of all available live communications, wherein the subset is selected based on one or more matching criteria associated with the first user and the second user.

In some implementations, the method includes: receiving, from the second client device, a request to view content associated with a profile of the first user prior to receiving the request to join the live communication; and in response to the request to view the content associated with the profile of the first user, causing presentation of the content associated with the profile of the first user at the second client device.

In some implementations, the method includes: receiving, from the second client device, a request to view content associated with a profile of the first user subsequent to receiving the request to join the live communication; and in response to the request to view the content associated with the profile of the first user, causing presentation of the content associated with the profile of the first user at the second client device concurrently to causing presentation of the live communication at the second client device.

In some implementations, the method includes: receiving, from the first client device, data indicative of one or more privacy settings associated with the live communication; and in response to receiving the data indicative of the one or more privacy settings, modifying the plurality of users of the social network to whom the data indicative of the live communication is provided.

In some implementations, causing presentation of the live communication at the second client device includes presenting a user-selectable element that enables the second user to view other users who are present in the live communication.

In some implementations, causing presentation of the live communication at the second client device includes presenting a user-selectable element that enables the second user to indicate a reaction to the live communication.

In some implementations, causing presentation of the live communication at the second client device includes presenting a user-selectable element that enables the second user to vote to match with the first user.

In some implementations, the forbidden content topic includes at least one of verbal assault, violence, assault, or sexual violence.

In some implementations, determining that the live communication includes the forbidden content topic includes receiving a report submitted by a user present in the live communication.

In some implementations, wherein determining that the live communication includes the forbidden content topic comprises implementing a machine learning model trained to identify the forbidden content topic.

In one general aspect, a method performed by a server for identifying a match between a first user and a second user, wherein the first user and the second user are users of a social network, the method includes: receiving, from a first client device associated with a group of users that includes the first user, a request to initiate a live communication to a plurality of users of the social network; in response to the request to initiate the live communication, providing data indicative of the live communication to the plurality of users of the social network, wherein the plurality of users include the second user; receiving, from a second client device associated with the second user, a request to join the live communication; in response to the request to join the live communication, causing presentation of the live communication at the second client device; receiving, from the second client device, a vote to match with the first user; receiving, from the first client device, a vote to match with the second user; in response to the votes by the first user and the second user: terminating the live communication; and enabling a one-to-one communication channel between the first user and the second user.

The live streaming function can provide one or more of the following advantages. First, the live streaming based discovery channel improves the quality of matches. For example, for a user of a social media application, it would be beneficial if the social media application facilitates matches that reflect the user’s preferences, e.g., suggesting a match between users having shared interests. The live streaming based discovery channel described allows a user to broadcast a live communication or a live stream to and interact with one or more other users before voting to match, thereby enabling users to vet their compatibility and establishing better matches. Once matched, the live streaming based discovery channel terminates the live communication and establishes a one-to-one communication channel between matched users, which further improves matchmaking. In addition, by terminating the live (broadcast) communication in favor of a one-to-one communication, the consumption of computing resources, e.g., processing cycles, memory, etc., is reduced. For example, the live streaming channel and the one-to-one communication channel can share a processing engine that is configured to transmit audio or video data from the user’s device to the server. In this example, a system implementing the live streaming based discovery channel saves computational power, memory, and time, e.g., by opening an additional data stream for one more user instead of opening two data streams for two users, and by saving computer storage using a shared processing engine.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of system for enabling functions within a virtual lobby.

FIGS. 2A-2B are block diagrams that illustrate examples of user interfaces for generating a profile.

FIG. 3A is a block diagram that illustrates an example of a user interface for interacting in the social networking environment.

FIG. 3B is a block diagram that illustrates an example of a user interface for interacting with virtual lobby functions.

FIGS. 3C-3D are block diagrams that illustrates examples of user interfaces for interacting within a speed dating audio function.

FIGS. 3E-3G are block diagrams that illustrate examples of systems for interacting within a singles evening audio function.

FIG. 4A is a block diagram that illustrates an example of a user interface for interacting within a live streaming function based discovery channel.

FIG. 4B is a block diagram that illustrates an example of a broadcasting user’s profile in response to a request to access the profile information from the live stream feed on the user interface.

FIGS. 5A-5D are block diagrams that illustrate examples of systems for live streaming functions.

FIGS. 6A-6B are block diagrams that illustrate examples of systems for users communicating within a live streaming function.

FIG. 7 is a block diagram that illustrates an example of a user interface for a discovery channel in a live streaming function.

FIG. 8 is a block diagram that illustrates an example of a system in a social networking environment.

FIG. 9 is a flow diagram that illustrates an example of a process for matching individuals in a social networking environment.

FIG. 10 is a flow diagram that illustrates an example of a process for providing a live streaming based discovery channel.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

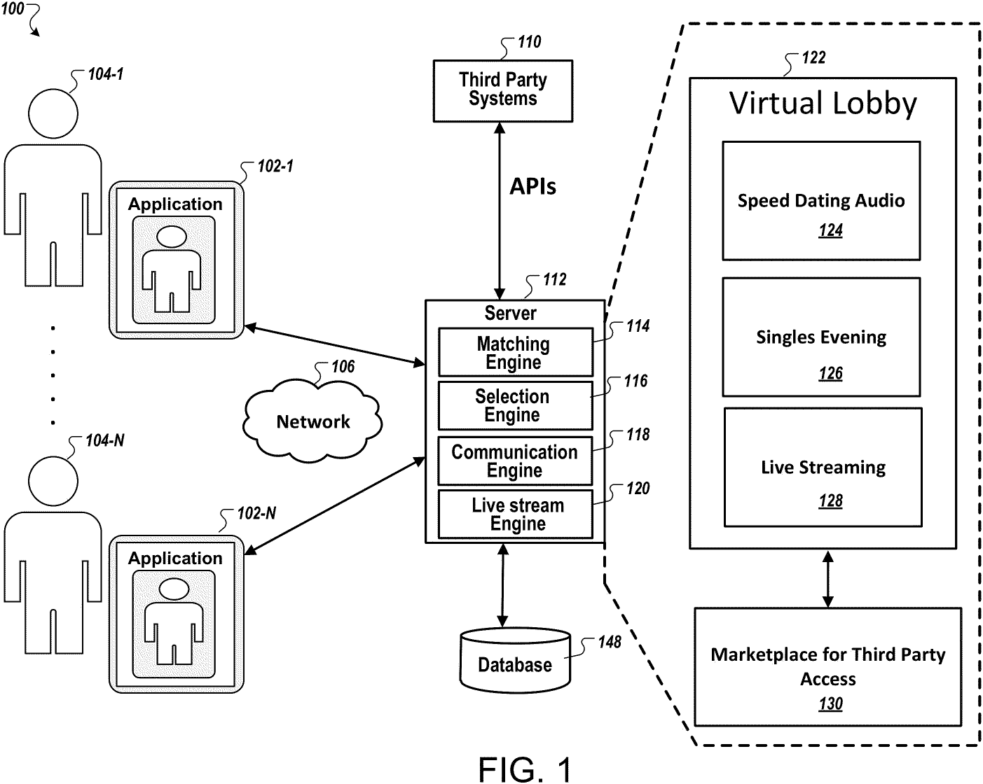

FIG. 1 is a block diagram that illustrates an example of system 100 for enabling functions within a virtual lobby. In some implementations, system 100 includes a plurality of users 104-1 through 104-N (hereinafter, collectively “users 104”) each associated with client devices 102-1 through 102-N (hereinafter, collectively “client devices 102”). Each of the users 104 can seek to use a social networking application offered by system 100, and in particular, the server 112. The server 112, which can be accessed by the client devices 102 over network 106, can offer the social networking application to each of the client devices 102. The client devices 102 can be, for example, a mobile device, a personal computer, a handheld device, a laptop, or some other device.

The client devices 102 can access the server 112 over the network 106 through a social networking application. The social networking application can enable users 104 to match with one another based on similarities and interests between the users 104. The server 112 can include one or more components to offer the social networking application. The one or more components can include a matching engine 114, a selection engine 116, a communication engine 118, and a live stream engine 120. Each of these components will be further described below.

The server 112 can access one or more databases 148 over a network 106. The database 148 can include information regarding the client devices 102 and information indicative of the users 104. The database 148 can also include historical data of previous matches between users. The database 148 and its functionalities will be further described below.

The server 112’s social networking application can include a virtual lobby 122. The virtual lobby 122 can include a user interface on the social networking application for users 104 to select or interact with one or more enhanced functions to try and match with others, in addition to matchmaking functions typically offered by the social networking application. For example, the virtual lobby 122 can include a speed dating audio 124, a singles evening 126, and a live streaming 128. The users 104 on their respective client devices can access each of these functions offered by the virtual lobby 122.

In some implementations, the server 122 can offer access to the virtual lobby 122 to third party systems 110. Specifically, the server 122 can enable third party systems 110 to access the virtual lobby 122 and its corresponding functions by way of one or more application programmable interfaces (APIs). The APIs can give the third party systems 110 an interface to the functions of the virtual lobby 122 to develop and provide additional functionality for the functions, e.g., speed dating audio 124, singles evening 126, live streaming 128, and others, to name a few examples. The third party systems 110 can include one or more external users or corporations seeking to access server 112 to improve and/or enhance the functionality of the virtual lobby 122.

The speed dating audio 124 can enable users to communicate and potentially match in a timed environment. If the users in a speed dating audio event do decide not to match, the users can jump to the next user after time has elapsed. The singles evening 126 can enable users to communicate in an open environment or by whispering to an individual such that others cannot hear. In the live streaming 128, each user of the social media application can initiate a live streaming and/or participate in live streams initiated by other users. In some examples, the live streaming is a communication channel that is open to users who request to join; that is, the live streaming is not a private conversation between two users. The live streaming also has an embedded feature for users to vote to match with other users of the social media application. In some examples, the voting is bidirectional, done both by a user who is broadcasting a live streaming (referred as a “broadcasting user”) and by one or more users (referred as a “viewing users”) who are participating the broadcasting user’s live streaming. When the broadcasting user and one or more of the viewing users each vote for one another, the discovery channel terminates the broadcasting user’s live streaming and enables the two (or more) users to continue to communicate with each other through a one-to-one communication channel.

Additionally, the server 112 can include a marketplace for third party access 130. The marketplace for third party access 130 can correspond to how the third party systems 110 access the virtual lobby 122 and its corresponding functions. Additionally, the marketplace for third party access 130 can give the third party systems 110 access to the database 148. In particular, the third party systems 110 can access the virtual lobby 122 and the corresponding functions through one or more APIs offered by the server 112 to the third party systems 110.

Additionally, the virtual lobby 122 can include additional functions. These additional functions can include functionality related to perform e-commerce transactions, such as, shopping for items, shopping for fashion items, auctioning items and purchasing items on auctions, as well as making reservations for future events, e.g., hotels, vacations, restaurants, theatrical performances. Additionally, the virtual lobby 122 can include functions related to performing business transactions outside the server 112 over the Internet. The users 104 and the third party systems 110 can access the marketplace for third party access 130 for performing the transactions related to e-commerce, as indicated above.

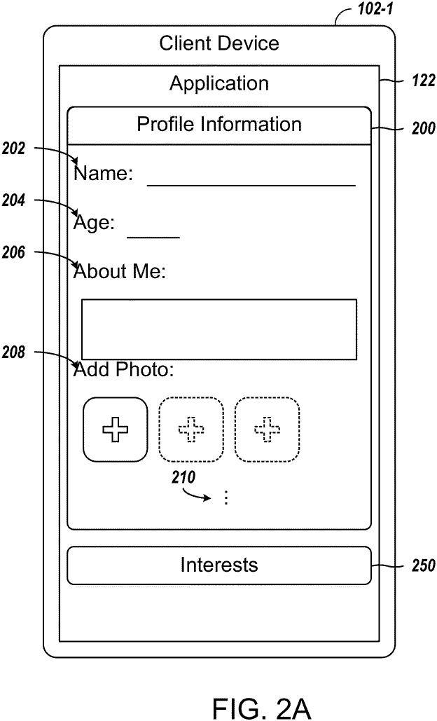

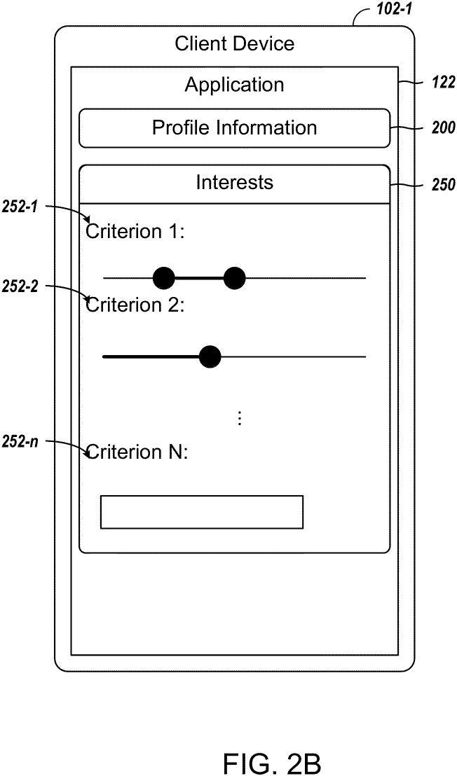

FIG. 2A is a block diagram that illustrates an example of a user interface 200 for generating a profile. The user interface 200 is presented to a user seeking to use the social networking application. Before interacting with others via the social networking application, the user can create a personal profile for participation in the social networking application. As illustrated on the user interface 200, the user can interact with the social networking application 122 of client device 102-1 to provide user profile information. The profile information can include, for example, the name 202 of the user, an age 204, biographical text 206, one or more photographs 208, and/or a variety of other fields 210. The other fields 210 can include, for example, city, links to social media profiles on other networks, religious beliefs, orientation, and other personal information about the user. Moreover, on the user interface 200, each user can specify their interests 250 by interacting with the button for the interests 250.

The user can provide his/her information for the personal profile by speaking into the client device 102-1, typing on a touch screen of the client device 102-1, or typing using a keyboard and mouse. In some implementations, the user can update his/her personal profile while using the social networking application. The personal profile can be updated and the changes can be reflected for other users to see at any time.

FIG. 2B is another block diagram that illustrates an example of user interface for generating a profile. FIG. 2B illustrates different user interfaces of the social networking application 122 on the client device 102-1. For example, the client device 102-1 can illustrate a button for the user interface 200 from FIG. 2A and the user interface for the interests 250 showing the interests of the user. The user can transition from user interface 200 for the user profile to the user interface for the interests 250 by selecting the button for the interests 250 shown in FIG. 2A. Additionally, the user can transition from the user interface for interests 250 to the user interface 200 for the profile by selecting the button for the user interface 200 for the user profile information shown in FIG. 2B.

In some implementations, the user can specify their characteristics or criteria to help improve the matchmaking of the social networking application. For example, as shown in FIG. 2B, a user can specify their interests 250 by interacting with a user interface to provide various criteria 252-1 through 252-N that the user is looking for in a match. These criteria can include, for example, an age of a potential match, a distance the potential match is from the user, hobbies, commitment disposition, orientation, or a combination of the above factors.

In some implementations, a matching engine can identify one or more of the criteria 252-1 through 252-N instead of or in addition to those specified by the user based on, for example, analysis of the user’s interactions. The matching engine can use the interests 250 designated by each user profile to generate matching criteria for use in identifying potential matches for the user. Additionally, the matching engine can take into account requests provided by the user for one or more potential matches.

Once a user profile has been completed, a user can begin to view the profiles of other users, while the user’s own profile is circulated among various other users in the social networking application. In some implementations, a user can receive a variety of profiles of other users who have been identified as potential matches based on their interests 250, e.g., identified criterion 252-1 through 252-N. The matching engine can provide the variety of profiles of other users to the client device 102-1 of the user based on deriving matching criteria from the interests 250 to criteria from the interests of other users. Based on the matching criteria between users, the matching engine can identify potential or recommended matches between users.

In response to the matching engine identifying potential or recommended matches, the matching engine can then provide the profiles of the potential matches to the user for review. Similarly, the matching engine can perform the match identification and providing of profiles to other users, e.g., users of client devices 102-2 through 102-N in addition to the user of client device 102-1.

Generally, the matching engine can determine one or more potential or recommended matches between users through a variety of processes. For example, the matching engine can use filters, applied rules, trained machine learning algorithms, or some combination of these, among others, to identify potential or recommended matches for a particular user. For example, the matching engine can generate one or more filters or rules based on the interests, e.g., interests 250, of a user, and can apply the filters or rules to users’ profile information for other users to identify a pool of applicants to provide as potential matches for the user. In another example, the matching engine can include a machine-learning model, e.g., a neural network model, which has been trained to identify features from the profile and interests of a particular user. The machine-learning model can process profile information for other users to identify potential matches for the user. For example, the machine-learning model can receive criterion and interests of user A and criterion and interests of user B and output a likelihood of a match between user A and B. If the matching engine determines the likelihood of a match, e.g., a percentage or statistic, is greater than the threshold value, then the matching engine can provide the profile of user B to the client device of user A and provide the profile of user A to the client device of user B as a recommended or potential match.

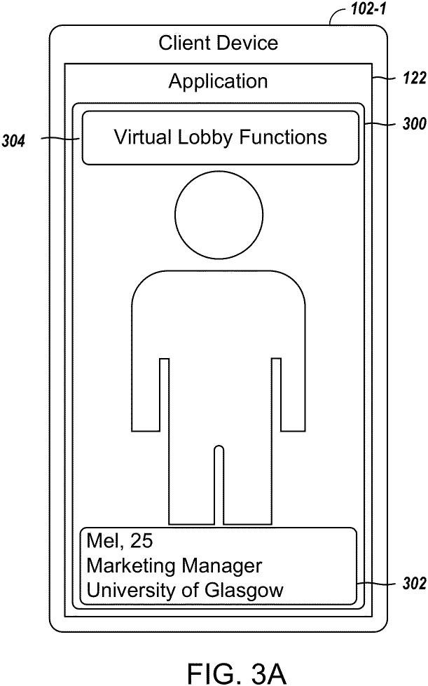

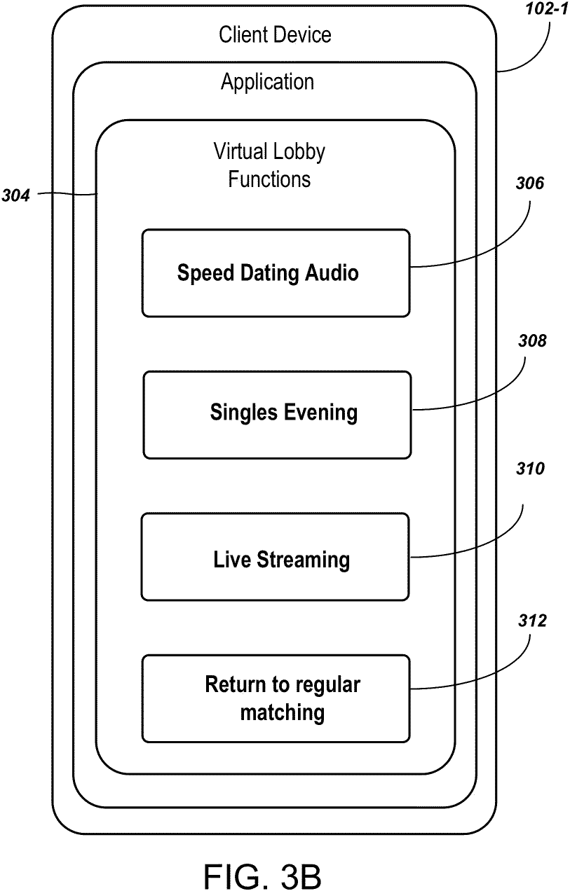

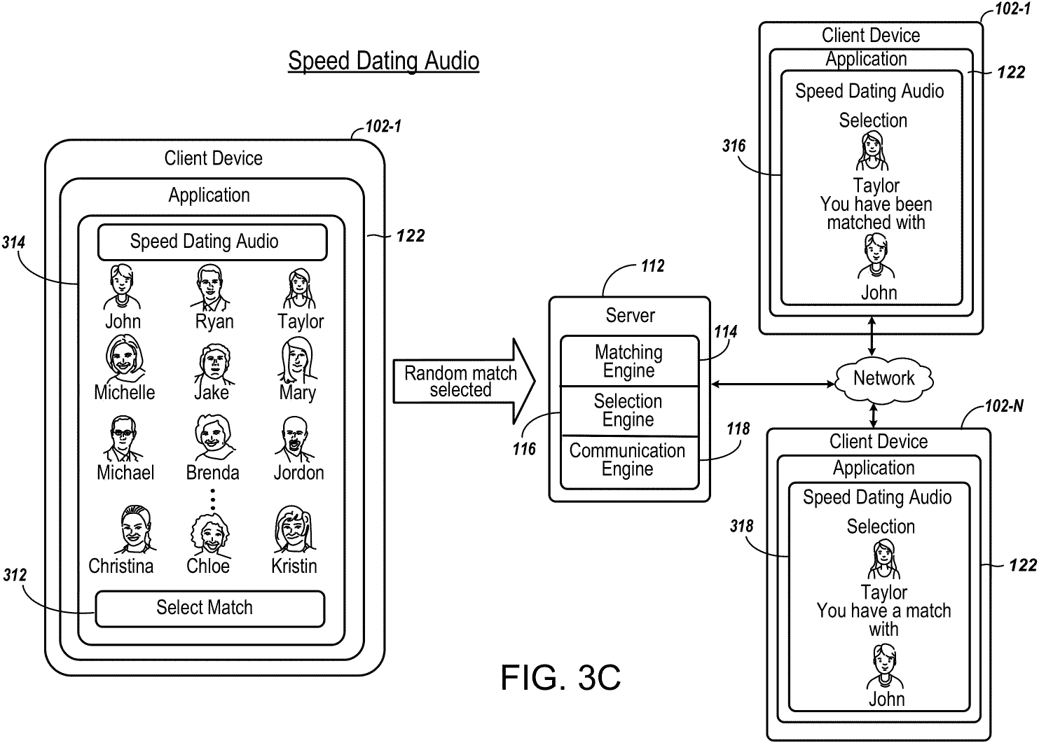

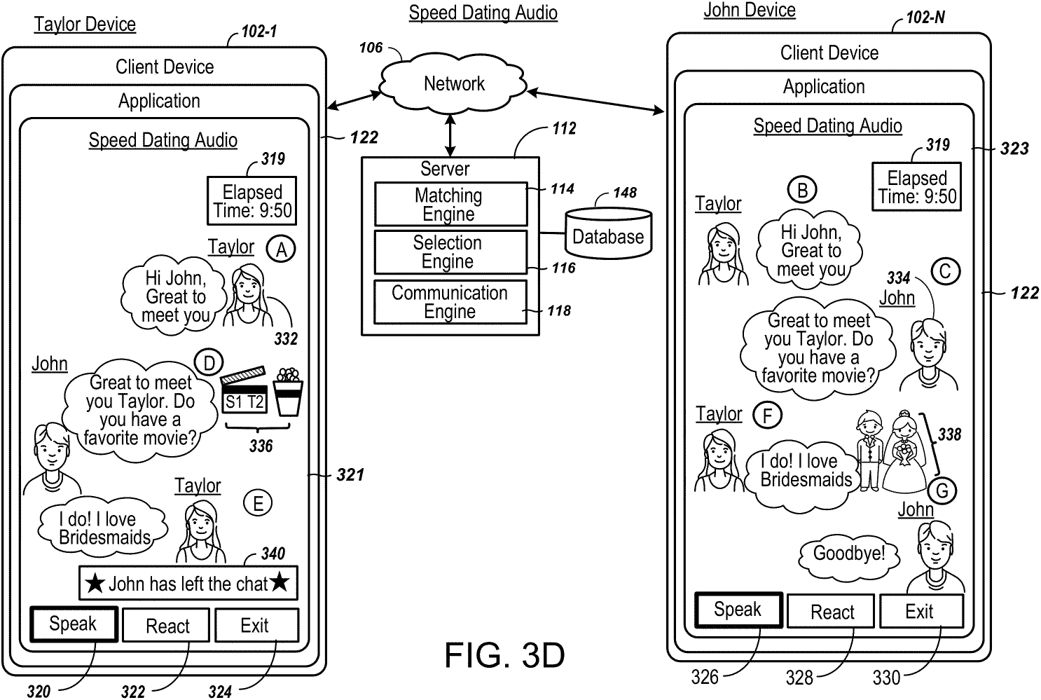

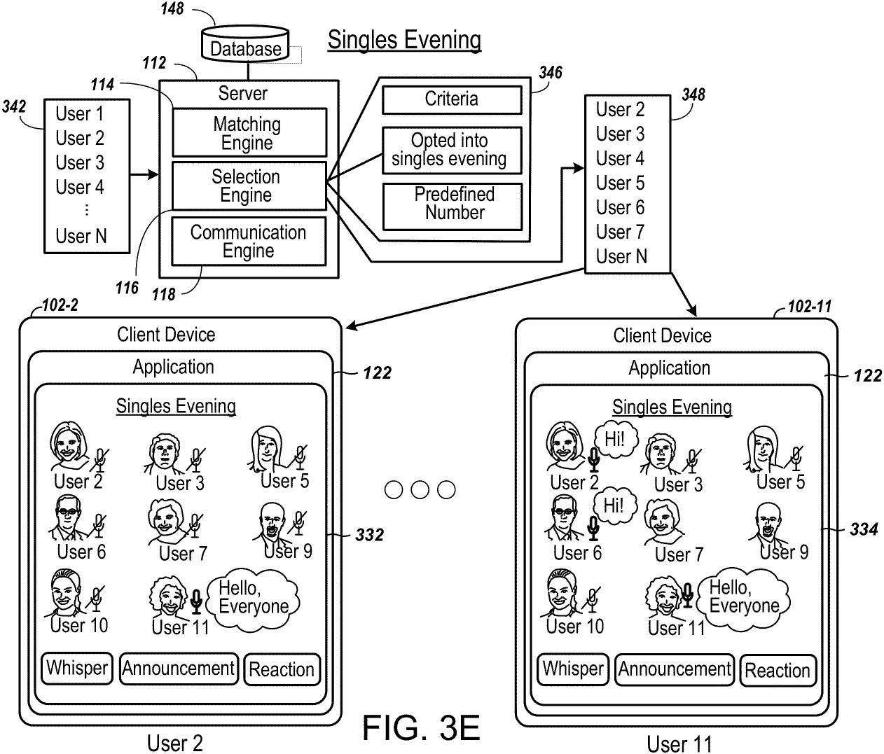

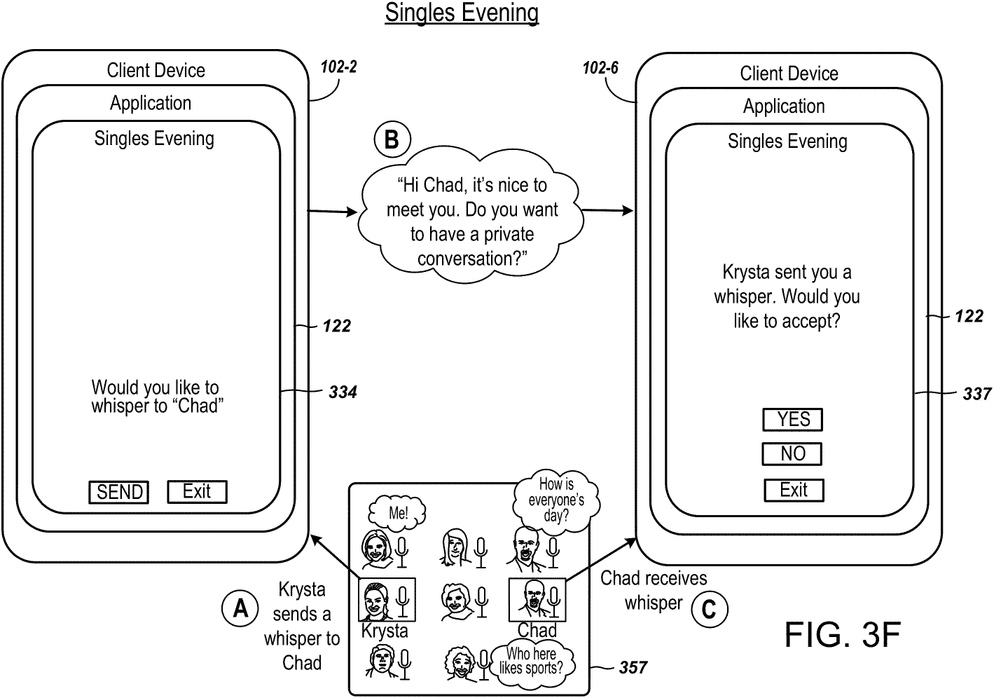

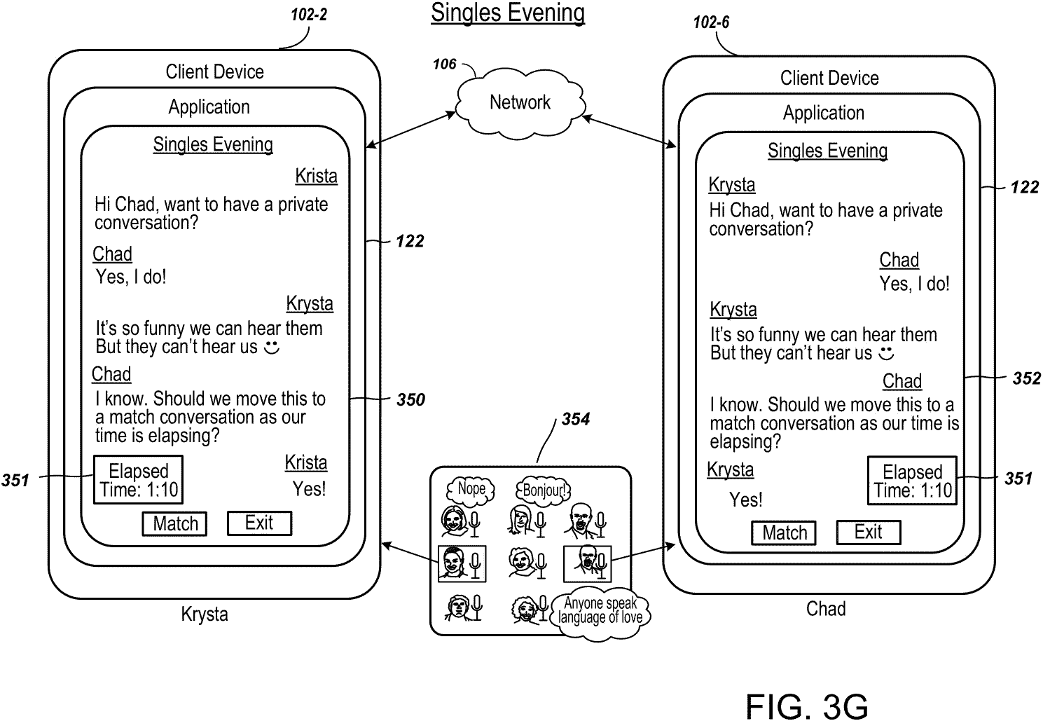

FIG. 3A is a block diagram that illustrates an example of a user interface 300 for interacting in the social networking environment. After the matching engine has identified one or more potential matches for a user, the matching engine can provide the profiles of the potential matches to the user for review. The user is then able to explore the provided match on his/her client device 102-1 in the social networking application 122. For example, as illustrated in FIG. 3A, the social networking application 122 executing on the client device 102-1 can display a user interface 300 that allows the user to view and explore the information that has been added to a potential match’s user profile. The user interface 300 can also include a prompt 302 that describes information about the user associated with the displayed user profile. The user interface 300 can also include virtual lobby functions 304, which will be further described below.

To ascertain a mutual agreement to connect two users together, each profile can be voted on by the viewing user. For example, after reviewing the personal profile of another user, the viewing user can vote “yes” indicating they would like to connect with that specific user, or vote “no” indicating they are not interested in connecting with that specific user.

In some implementations, the viewing user can vote “yes” by interacting with the display of the client device. For example, the user can click and drag the personal profile of another user by swiping the profile off the screen of the client device 102-1 in a particular direction, e.g., right, left, up, down, or other. In some implementations, the viewing user can vote “no” by interacting with the display of the client device. For example, the user can click and drag the personal profile of another user by swiping the profile off the screen of the client device 102-1 in an opposite direction from the particular direction to vote “yes.” If the user swipes right for a vote “yes” on the display, then the user can swipe left for a vote “no” on the display. In some implementations, if the user has voted “yes” for a profile of another user, the matching engine can place the profile of the user into the queue of profiles to be viewed by the other user, e.g., the user voted as “yes.” Through this mechanism, the matching engine is able to accelerate the pace with which two users view each other’s profiles than would typically occur in a purely organic system of profile selection.

When two users both mutually vote “yes” upon the viewing of the other user’s profile, a connection, e.g., a match, is established between the two users. Once a match is established, the matching engine can supply a notification of the match to both of the matched users with a prompt to contact the other matched user. On the other hand, when one votes “yes” but the other user votes “no,” no further connection is established between the two users, and their profiles are not shown to each other again, e.g., or they may be shown again depending on changes with their profile, criterion, search parameters, or due to a time elapsing. In this manner, the matching engine allows the intention of each user within the social network to be communicated.

In some implementations, the two matched users are directed to a messaging system of the social network to contact the other matched user. Once users are within the messaging system, the communication engine of the server can manage the messages sent back and forth between the two users. In some implementations, the communication engine can display elements of user’s profile in order to increase recognition of the other user. The elements can include, for example, name, age, and photographs. Additionally, the communication engine can enable the matched users to speak in an auditory manner. In some implementations, the communication engine can convert the audio to one or more audible annotations to provide to both client devices. The audible annotations can be provided in addition to or alternatively from the provided audio. The audible annotations will be further described below.

In some implementations, the user interface 300 includes virtual lobby functions 304 to enhance the communication functionality of the social media application. The virtual lobby functions 304 enable a user to try different communication mediums to interact with matched or unmatched users, e.g., to identify potential matches with other users. The virtual lobby functions 304 offer an enhanced experience of the social media application different from the matchmaking previously described. The virtual lobby for the virtual lobby functions 304 can function as a junction where a user can select from a variety of functions.

FIG. 3B is a block diagram that illustrates an example of a user interface for interacting with virtual lobby functions 304. The virtual lobby functions 304 are different functions for enabling a user to interact with potential matches. The virtual lobby functions 304 include speed dating audio 306, singles evening 308, and live streaming 310. Additionally, within the virtual lobby functions 304, the user can return to regular matching 312.

The user can access the speed dating audio 306, the singles evening 308, the live streaming 310, and return to regular matching 312 by interacting with their corresponding buttons. The user can tap a button to enter a corresponding function or speak the name of the function to enter the corresponding function.

FIG. 3C is a block diagram that illustrates an example of a user interface 314 for interacting within a speed dating audio function. In some implementations, the user can select the speed dating audio 306 from the virtual lobby functions 304 and proceed to have an audio-based interaction with another user. The speed dating audio function can include a simulated lobby that enables users to interact and communicate with one another using audio channels. Audio communication offers an additional layer of enhanced functionality for users seeking companionship.

In the social networking application, when two users are matched by the system, the two users match typically based on visual cues of the user’s profile. These visual cues can be, for example, photographs, similar criterion, similar interests, proximity, and other values. The visual cues can be representative of the matching criteria indicated by a user. By adding an audio communication channel through which matched users can interact, two matched users can communicate and hear one another’s voice. This is an advantage in the social networking application when determining if a user is interested in the matched user. Additionally, if the two matched users can communicate well audibly in the social networking application, then the two matched users may be more likely to decide to meet in person following the conversation via the audio speed dating function.

In some implementations, the social networking application 122 of the client device 102-1 can provide a user interface 314 that illustrates multiple users shown in a simulated lobby of the speed dating audio function. For example, the user interface 314 illustrates John, Ryan, Taylor, Michelle, Jake, Mary, Michael, Brenda, Jordon, Christina, Chloe, and Kristin all included within the simulated lobby of the speed dating audio function. The selection engine 116 can pre-select a number of users to be included with the simulated lobby. For example, the selection engine 116 can indicate that nine users is the maximum amount of users included within the simulated lobby. The selection engine 116 can also pre-select other numbers of users to include within the simulated lobby.

In some implementations, the selection engine 116 can identify the users to include within the simulated lobby of the speed dating function based on matching criteria of the users. For example, the selection engine 116 can receive a large number of requests from a subset of client devices 102 requesting to use the speed dating audio function. For example, the selection engine 116 can receive 100, 1000, 10,000, or more requests from the client devices 102. The selection engine 116 can partition these requesting users into groups based on their matching criteria. For example, the selection engine 116 can partition the requesting users using at least one of the following: proximity, interests, age, criterion, and other factors. In this manner, the selection engine 116 can partition the 1000 requesting users into 100 groups of 10 users, for example, each group being partitioned based on the matching criteria. The selection engine 116 can group individuals with similar matching criteria together. Alternatively, the selection engine 116 can group individuals with different criteria together.

In some implementations, the user interacting with the social networking application 122 can indicate they desire a match in the speed dating audio function by interacting with the button 312 for selecting a match. The social media application can match the user with another user within the simulated lobby of the speed dating function. The client device 102-1 can receive an indication that the user interacted with the button 312 and can transmit a request to the server 112 for a match. The matching engine 114 can receive the request from the client device 102-1 and can determine a match for the user associated with the client device with another user in the simulated lobby. In some implementations, the matching engine 114 can match the user with another user in the simulated lobby based on a random function. For example, the matching engine 114 can use a random seed to identify a user for the user of client device 102-1. In other implementations, the selection engine 116 can match the user with another user in the simulated lobby based on a degree of similarity. For example, the matching engine 114 can match the user to another user based on a similarity of two users’ matching criteria.

In response to the matching engine 114 matching two users from the simulated lobby of the speed dating function, the matching engine 114 can identify each user’s profile to provide to the corresponding client devices. For example, the client device 102-1 can be associated with the user Taylor. The matching engine 114 can determine a match between Taylor and another user named John. The matching engine 114 can retrieve the user profile for John and provide John’s user profile to the client device 102-1 for Taylor. Similarly, the matching engine 114 can retrieve the user profile for Taylor and provide Taylor’s user profile to the client device 102-N for John. As illustrated in FIG. 3C, after the matching engine 114 has identified Taylor and John as matches, the client device 102-1 can provide a user interface 316 for Taylor to indicate that “Taylor, you have been matched with John.” Similarly, the client device 102-N can provide a user interface 318 for John to indicate that “John, you have been matched with Taylor.” The matching engine 114 can identify matches for each of the users included in the simulated lobby of the speed dating audio function.

FIG. 3D is another block diagram that illustrates an example of a user interface for interacting within a speed dating audio function. In particular, FIG. 3D illustrates two client devices, e.g., client device 102-1 and client device 102-N, communicating with one another after having been matched together by the matching engine 114. The communication engine 118 facilitates communication between the client device 102-1 and client device 102-N by allowing messages to transfer over the network 106. FIG. 3D illustrates various operations in stages (A) through (G) which can be performed in the sequence indicated or another sequence.

In some implementations, each client device provides a user interface for communication between the matched users. For example, client device 102-1 provides a user interface 321 for Taylor and client device 102-N providers a user interface 323 for John. In this example, Taylor and John can communicate with one another in an audio manner. Taylor can speak into her client device 102-1 and can communicate with John while John can speak into his client device 102-N and can communicate with Taylor.

During the speed dating audio function, the matched users can only communicate during the elapsed time. After the elapsed time has ended, the matched session between Taylor and John closes. An implementer of the server 112 can set an amount of time for the elapsed time. For example, the elapsed time can be set to 10 minutes. The elapsed time can be used to improve the decision making process for moving the conversation along. For example, the user interface 321 illustrates an elapsed time 419 for client device 102-1 and the user interface 323 illustrates the elapsed time 319 for client device 102-N.

In some implementations, the two matched users communicate with one another in an audio session during the speed dating audio function. For example, Taylor can speak into client device 102-1, and the client device 102-1 can provide the audio to the communication engine 118 over network 106. The communication engine 118 can receive the audio from the client device 102-1 and convert the received audio to one or more audible annotations. For example, the communication engine 118 can use speech recognition functions, machine learning techniques, acoustic processing, and other digital signal processing techniques to identify the spoken words in the received audio.

In response, the communication engine 118 can convert the identified spoken words to audible annotations. For example, the audible annotations can include emoji’s, pictures, voices spoken by avatars, and other emotions that represent a context of the spoken words. If Taylor spoke the words “I like to eat cake,” for example, then the communication engine 118 can convert the words “I like to eat cake” into one or more emoji’s or pictures showing a piece of cake. In response to generating the audible annotations of the spoken words, the communication engine 118 can provide both the (i) spoken audio from the client device 102-1 and (ii) the generated audible annotations to the recipient device, e.g., client device 102-N. Similarly, the client device 102-N can provide spoken words to the communication engine 118, and the communication engine 118 can provide both the (i) spoken audio from the client device 102-N and (ii) the generated audible annotations to the recipient device, e.g., client device 102-1. This process can repeat until (i) the elapsed time has reached zero or (ii) one or both of the users have decided to exit the speed dating audio session.

As shown in the example in FIG. 3D, Taylor can interact with button 320 to speak to the client device 102-1. For example, Taylor can press and hold down the button 320 to speak into the client device 102-1 and record an audio message to transmit to John’s client device 102-N. Additionally, Taylor can press the react button 322 on client device 102-1 and provide a specific emoji or a specific reaction to a message, e.g., exclamation, heart, thumbs up, thumbs down, or some other reaction. Taylor can also press the exit button 324 to exit the speed dating audio at any time. Similarly, John can interact with speak button 326, react button 328, and exit button 330.

During stage (A), Taylor can press the speak button 320 and speak into the client device 102-1 to say “Hi John, Great to meet you.” The client device 102-1 can transmit this recorded voice message to the server 112, where the communication engine 118 can generate audible annotations of the message and provide the message to John’s device 102-N.

During stage (B), John can receive Taylor’s message at his client device 102-N. Additionally, the communication engine 118 can generate an avatar of Taylor and provide the avatar to John’s client device 102-N. An avatar corresponds to a digital representation of a person that represents an online user. For example, Taylor’s avatar can illustrate her digital representation and John’s avatar can illustrate his digital representation. When the client device 102-N receives the message, John can view Taylor’s avatar speaking the message of “Hi John, Great to meet you” or acting out the message, e.g., by waving to represent a hello, on his user interface 423.

During stage (C), John can press the speak button 326 and speak into the client device 102-N to say “Great to meet you Taylor. Do you have a favorite movie?” In some implementations, the client device 102-N can generate an avatar of the user. For example, client device 102-N can generate John’s avatar and use that for communications between John’s client device and Taylor’s client device.

During stage (D), Taylor can receive John’s message at her client device 102-1. When the client device 102-1 receives the message, Taylor can view John’s avatar speaking the message of “Great to meet you Taylor. Do you have a favorite movie?” Additionally, the communication engine 118 provides one or more audible annotations 336 that represent a characteristic of John’s message. As shown in user interface 321, the communication engine 118 can generate a film clapboard and a bag of popcorn based on John’s question about Taylor’s “favorite movie?” The audible annotation can illustrate movement and be illustrated in various colors. The user interface 321 can display the film clapboard and the bag of popcorn. In some implementations, the recipient of the message receives the audible annotations. In other implementations, both client devices can receive and display the audible annotations when the communication engine generates one or more audible annotations for a corresponding message.

During stage (E), Taylor can press the speak button 320 and speak into the client device 102-1 to say, “I do! I love Bridesmaids.” In response, the client device 102-1 can provide the audio message to the communication engine 118 over the network 106, which subsequently provides the audio message and a generated audible annotation to the recipient device, e.g., client device 102-N.

During stage (F), the client device 102-N receives the audio message and the generated audible annotation from the communication engine 118. The client device 102-N can display on the user interface 423 Taylor’s avatar speaking “I do! I love bridesmaids” and the corresponding generated audible annotation 438 illustrating a bride and a groom. Additionally, the client device 102-N can play the avatar speaking “I do! I love bridesmaids” through a speaker.

During stage (G), John can press the speak button 326 and speak into the client device 102-N to say “Goodbye!” out of fear of marriage. The audible annotations can help the users with contexts of the corresponding messages. The client device 102-N can provide the spoken message “Goodbye!” to the communication engine 118, which subsequently provides the message to the client device 102-1. In response to saying goodbye, John can press the exit button 330 to exit from the speed dating audio function with Taylor. The server 112 can receive the indication from client device 102-N that John has exited the chat, and transmit a notification to the client device 102-1 indicating the same. In response, the client device 102-1 can provide to the user interface 326 a display 340 that indicates, “John has left the chat.”

In some implementations, both users can return to the simulated lobby shown in the user interface 314. When John or Taylor, for example, presses the select match button 312 again, the matching engine 114 can ensure that John and Taylor are not matched again based on a determination that they have matched together before. If the matching engine 114 determines that each user within the simulated lobby has matched with one another before, the selection engine 116 can acquire more people to include within the simulated lobby. Similarly, the users can exit from the simulated lobby and return to user interface 304 (as shown in FIG. 3B).

In some implementations, a user can decide to connect with a previously connected user from a speed dating audio only session. For example, user Jake can decide to initiate contact with user Mary, after communicating with user Brenda, user Kristin, and user Chloe. User Mary can either accept or deny user Jake’s initiation. If user Mary accepts user Jake’s initiation, then the user Mary can initiate the conversation. The user Jake can only respond to user Mary if user Mary initiates the conversation after accepting the initiation.

In some implementations, two users may decide to communicate with one another following a speed dating session. For example, if John and Taylor had decided to continue the conversation in a private chatroom outside the speed dating audio function, then either user can select a button on their respective user interfaces that enables initiation of a private chatroom without an elapsed time. In some cases, when the elapsed time ends, the user interfaces can ask the respective users whether they desire to exit to the virtual lobby or continue the conversation in a private chatroom. If both users’ select continue the conversation in a private chatroom, then the conversation can continue in the private chatroom. However, if at least one of the users selects to exit to the simulated lobby (when the other user selected to continue the conversation in the private chatroom), both users can exit to the simulated lobby or exit out of the simulated lobby and return to regular matching at user interface 304 shown in FIG. 3B. In some implementations, if the users exit to the simulated lobby, each user can jump to communicating with another user.

In some implementations, a female in the speed dating audio function can have additional control over the conversation. In some examples, (i) a female can end the speed dating session early, whereas the male cannot; (ii) a female can extend a length of the speed dating session to continue the conversation, whereas the male cannot; (iii) a female may have the option to vote whether to connect with the male, whereas the male cannot vote but is only matched with the female as a result of the females vote. In other examples, the female in the speed dating audio session can initiate the conversation, whereas the male has to wait for the female to initiate. If the female does not initiate the conversation with the male before the timer 319 has elapsed, then no communication occurs. Other examples are also possible.

FIG. 3E is a block diagram that illustrates an example of a user interface for interacting within a singles evening audio function. In some implementations, a user can select the singles evening 308 function from the user interface 304 shown in FIG. 3B that shows the virtual lobby functions and proceed to identify matches using the singles evening function. The singles evening function can include a simulated lobby that enables user to interact and communicate with one another using different audio channels.

In some implementations, various users can communicate with another in a simulated lobby in the singles evening function. Users can request to enter the simulated lobby of the singles evening function from each of their respective client devices using the social networking application 122. The client devices can transmit requests to the server 112 to enter the singles evening function. The server 112 can pre-select a number of users to join the singles evening function based on a select criteria. The criteria can include, for example, user interest, user location, user age, and other characteristics defined by the profile of the user.

As illustrated in the example of FIG. 3E, the server 112 can receive requests from multiple users 342 to enter the singles evening function. The multiple users 342 can range from user 1 to user N. The selection engine 116 can generate the simulated lobby for a pre-selected number of users based on the characteristics 346. The characteristics 346 can include, for example, matching criteria of the users, whether the users have opted into the singles evening function, and a pre-defined number of users to include in the simulated lobby of the singles evening. The selection engine 116 can select, for example, users 2 through 11 to include in the simulated lobby based on similar age, interests, location, and based on a maximum number of ten users for the simulated lobby. As illustrated in FIG. 3E, the selection engine 116 selects the group 348 of users 2 through 11. The server 112 can then transmit notifications to the client devices of each users 2 through 11 to notify the corresponding users of their entry into a particular simulated lobby of the singles evening function.

The client devices 102-2 through 102-11, e.g., associated with users 2 through 11, can display a user interface on the social networking application 122 for the singles evening function. For example, client device 102-2 can display a user interface 332 for the singles evening function and the client device 102-11 can display a user interface 334 for the singles evening function.

The user interface 334 illustrates the various users, e.g., users 2 through 11 for example, selected by the selection engine 116 for the simulated lobby of the singles evening function. As illustrated in FIG. 3E, the client device 102-2 includes the user interface 334 showing users 2 through 11, their corresponding faces, and a microphone within proximity of each face. The faces of the users can correspond to a picture from their respective user profile, an avatar of the user, or another photo entered by the user specifically for the singles evening function. Additionally, the user interface can display a microphone within proximity of each face. The microphone can be crossed out with a diagonal on the display to indicate that the corresponding user is not speaking or is mute. Additionally or alternatively, when a user speaks, the microphone can display an indication, e.g., a highlight or a bright color, to indicate visually which user is speaking to the other users. In some implementations, as the user speaks, the display can visualize the words spoken by the user. For example, the user interface 332 can illustrate that user 11 speaks to say “Hello everyone” while user 11’s corresponding microphone is highlighted. Similarly, the user interface 334 can illustrate that user 2 speaks to say “Hi!” user 6 speaks to say “Hi!”, and “user 11 speaks to say “Hello, Everyone”.

Each user interface can include one or more graphical user interface buttons for interacting in the singles evening function. For example, both user interfaces 332 and 334 include a whisper GUI button, an announcement GUI button, and a reaction GUI button. The social networking application 122 can offer users the ability to perform a whisper, which enables a user in the simulated lobby to “whisper” or send a private direct message to another user within the simulated lobby. For example, user 2 can decide to whisper to user 6 by pressing the whisper GUI button on the user interface 332 and indicating a desired recipient of the whisper. The user 2 can provide a message, e.g., text or auditory, to user 6. When user 6, for example, receives the user 2’s whisper, only user 6 or the recipient can receive the message. No other users within the simulated lobby will be aware of or hear the transmitted whisper. More details regarding the whisper will be further described below.

In another example, user 2 can decide to make an announcement to the users within the simulated lobby. For example, user 2 can (i) interact with the announcement GUI button and (ii) provide an announcement or message to the users within the simulated lobby. User 2 can interact with the announce GUI button by pressing the GUI button or providing a verbal instruction for the social networking application 122 to select the GUI button. After interacting, user 2 can provide the announcement or message to the group within the virtual lobby. Each of the users within the virtual lobby can receive and hear the announcement on their corresponding client devices. In some examples, the volume of the announcement can be increased relative to the volume of the rest of the conversation so each user in the simulated lobby hears the announcement. In some cases, the social networking application can receive the announcement or message and convert at least a portion of the announcement to an audible annotation to display within the simulated lobby for each user to see.

In another example, user 2 can decide to provide a reaction to the users within the simulated lobby. For example, user 2 can (i) interact with the reaction GUI button and (ii) provide a specific reaction for the users within the simulated lobby. Similar to the announcement GUI button, user 2 can press the reaction GUI button or provide a verbal instruction for the social networking application 122 to select to the reaction GUI button. After interacting with the reaction GUI button, the user 2 can select a particular reaction for a list of reactions on the user interface 332. The list of reactions can include, for example, a list of emoji’s, avatars, messages, digital fireworks to display in a background of the simulated lobby, a bit-moji, or another type of emphasizing display in the background of the simulated lobby. In other examples, the reaction can correspond to an audible emoji, in which a user can provide a vocal message, and the social networking application 122 converts the vocal message to one or more audible annotations of the vocal message.

In some implementations, the social networking application 122 can provide different volume levels for the different functions. For example, the conversation between each of the users within the simulated lobby can be set to a first volume level. The first volume level can be a low volume level to ensure each of the users’ conversation does not overpower the others. The social networking application 122 can set conversation from an audible-emoji to be a different level than the first volume level. For example, the social networking application 122 can set a second volume level for conversation from an audible-emoji to be higher than the first volume level to direct users’ intention to that conversation within the simulated lobby. In another example, the social networking application 122 can set a third volume level of background noise within the virtual application to give a “bar-like” appearance to the simulated lobby. The third volume level can be lower than the second and the first volume levels. The background noise can be, for example, music, low noise conversations, movements, and other noises that may be heard in a typical bar or restaurant environment.

Each of the users can provide a whisper to another user in the simulated lobby or an announcement or reaction to all of the users in the simulated lobby. The users can also end their participation in the singles evening function by pressing an exit GUI button on their respective displays. Exiting the singles evening function can return a particular user to the user interface for the virtual lobby functions 304.

FIG. 3F is another block diagram that illustrates an example of a user interface for interacting within a singles evening audio function. For example, FIG. 3F illustrates an example when user 2 wishes to send a whisper to user 6. The client device 102-2 of user 2 can facilitate the transmission of a whisper to client device 102-6 of user 6. The processes shown in FIG. 3F can illustrate how the social networking application 122 performs a whisper in response to a user interacting with the whisper GUI button from FIG. 3E. FIG. 3F illustrates various operations in stages (A) through (C) which can be performed in the sequence indicated or another sequence.

During stage (A), a user can request to send a whisper to another user within the simulated lobby. For example, as illustrated in FIG. 3F, Krysta requests to send a whisper to Chad. Krysta can request that her client device 102-2 transmit a whisper by pressing the whisper GUI button from the user interface 332.

During stage (B), Krysta’s client device 102-2 confirms that Krysta would like to send a whisper to Chad on user interface 334. Krysta can either send the whisper or exit out of the whisper. In some implementations, Krysta can generate a customized message to send in the whisper. The customized message can include, for example, “Hi Chad, it’s nice to meet you. Do you want to have a private conversation?” In some examples, the initial whisper can be an audio message, a text message, or both. In other implementations, Krysta’s client device 102-2 can transmit a default whisper message to the recipient. The default message can include, for example, “Krysta would like to send a whisper to you. Do you accept?” The client device 102-2 can transmit the whisper to client device 102-6 through the communication engine 118 of the server 112.

During stage (C), Chad’s client device 102-6 can receive the whisper from client device 102-2. In response to the client device 102-6 receiving the whisper from client device 102-2, client device 102-6 can display a user interface or display 337 with a message that reads, “Krysta sent you a whisper. Would you like to accept?” Chad can respond to the whisper request in a variety of manners. Chad can accept the whisper request by interacting with the YES GUI button on the display 337. Chad can also decline the whisper request by interacting with the NO GUI button on the display 337. Similarly, Chad can decline the whisper request and exit the singles evening function by interacting with the Exit GUI button on the display 337.

In some implementations, the two users within the whisper request can view the whisper request. Viewing the whisper request can correspond to accepting the whisper request, as illustrated on the user interface or 337, and accessing the whispering message, e.g., reading and/or listening to the whisper message. The other users, besides Krysta and Chad, may not be aware that Krysta has sent a whisper communication to Chad. In response to Krysta and Chad communicating after Chad accepts Krysta’s whisper request, Krysta and Chad can communicate with one another, e.g., via audio and/or text, while the other users within the simulated lobby can communicate with one another. The other users within the simulated lobby cannot hear or see communications during Krysta and Chad’s whisper or any additional whispers. However, while Krysta and Chad communicate with one another during the whisper function, Krysta and Chad can still hear and view the communications from the other users within the simulated lobby. For example, as illustrated in FIG. 3F, Krysta and Chad can hear a user within the simulated lobby 357 ask, “Who here likes sports?” another user answer the question “Me!”, and another user ask, “How is everyone’s day?” Thus, users communicating in response to a whisper request can hear conversations and announcements occurring within the simulated lobby but the users within the simulated lobby cannot hear or see that conversations occurring in response to the whisper request.

FIG. 3G is another block diagram that illustrates an example of a user interface for interacting within a singles evening audio function. For example, FIG. 3F illustrates an example where Krysta and Chad are communicating in a private whispering chatroom. During the private whispering chatroom, Krysta and Chad can communicate with one another using their respective client devices, e.g., client device 102-2 and client device 102-6, and can hear and/or view the ongoing conversations outside the private whispering chatroom within the simulated lobby 354.

In some implementations, the client devices 102-2 and 102-6 can communicate over the network 106 and through the server 112. The server 112, and more specifically the communication engine 118, can process the messages sent back and forth between client device 102-2 and 102-6. For example, as illustrated on the user interface 350 of Krysta’s client device 102-2 and the user interface 352 of Chad’s client device 102-6, the conversation in the private whispering chatroom can include: Krysta - “Hi Chad, want to have a private conversation?” Chad - “Yes, I do!” Krysta - “It’s so funny we can hear them but they can’t hear us :)” Chad -“I know. Should we move this to a match conversation as our time is elapsing?” Krysta -“Yes.”

While the two users communicate in the private chatroom, the other users within the simulated lobby 354 can communicate with one another. For example, as illustrated in FIG. 3E, one user can ask, “Anyone speak language of love?” Two users respond to the question by speaking “Nope” and “Bonjour!” In some implementations, users within the simulated lobby 354 can communicate with one another for each user to visualize or within a private whisper chatroom. The users can request to exit the simulated lobby 354 by indicating on their respective client device to exit the chatroom.

The private whispering chatroom can include a timer, e.g., timer 351, which indicates an amount of time remaining in the chatroom. Once the timer has elapsed, the two users, e.g., Krysta and Chad, the private whispering chatroom ends and the two users can proceed to do the following: (i) return to the simulated lobby 354, (ii) move to a matched conversation without an elapsed timer, or (iii) exit the simulated lobby 354. An implementer of the social networking application 122 can set a length of time for the timer 351.

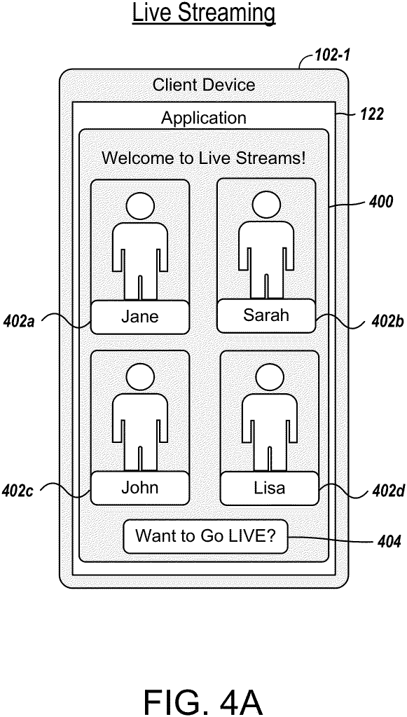

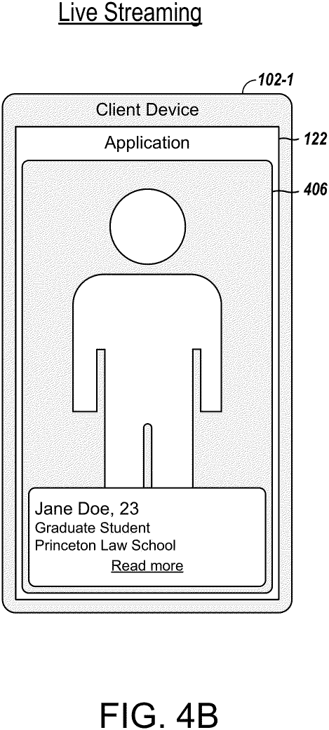

FIG. 4A is a block diagram that illustrates an example of a user interface 400 for interacting within a live streaming function based discovery channel. In some implementations, a user can select the live streaming 310 function from the user interface 304 shown in FIG. 3B that shows the virtual lobby functions and proceed to identify matches using the live streaming function. The social network application 122 executing on the client device 102-1 displays the example user interface 400 in response to selecting the live streaming 310 function, also referred as a live stream feed. The live stream feed on the user interface 400 includes available live communications (or live streams) 402a-402d and a user selectable element to initiate a live streaming, e.g., Go LIVE button or user selectable element 404. In some implementations, the live stream engine 120 displays a set of available live streams 402a-402d in chronological order, displaying a live streaming that is initiated first before a live streaming that is initiated later. In some implementations, the system 100 displays live streams by particular users who have been identified as potential matches, e.g., based on their interests 250. For example, the matching engine 114 can derive matching criteria from the interests 250, and can use the matching criteria to identify potential matches. In general, the matching engine 114 can use filters, applied rules, machine learning, or combinations of them, among others, to identify potential matches for a user. For example, the matching engine 114 can generate one or more filters or rules based on the interests of a user, and can apply the filters or rules to profile information for other users to identify potential matches for the user. The matching engine 114 can include a machine-learning model (e.g., a neural network model) trained to identify features from the interests of a user, and the machine-learning model can process profile information for other users to identify potential matches for the user. The matching engine 114 can send identified potential matches and their live streams (if available) to the live stream engine 120. Then, the live stream engine 120 can transmit data to, for example, the client device 102-1 to cause the social network application 122 executing on the client device to display available live communications through the live stream feed on the user interface 400. When a user selects the user selectable element 404, e.g., Go LIVE button, the user becomes a broadcasting user; the social network application 122 provides data indicative of the live communication by the broadcasting user, e.g., audio and/or video data from the broadcasting user’s client device 102-1, to the server 112. The server 112, e.g., the live stream engine 120, then transmits the data indicative of the live streaming to the client devices of one or more other users. In some implementations, the system 100 receives the data indicative of the live streaming from the broadcasting user’s client device via the network 106, and the network 106 transmits the data back to the server 112. In some implementations, the broadcasting is conducted via a peer-to-peer (P2P) network configuration. The viewing users can then access and participate in the broadcasting user’s live communication by selecting the broadcasting user’s live streaming, e.g., 402a, from the live stream feed 400.

FIG. 4B illustrates an example of a broadcasting user’s profile 406 in response to a request to access the profile information from the live stream feed on the user interface 400, e.g., by selecting 402a and requesting to view Jane’s profile information (instead of joining Jane’s live streaming). The live stream feed 400 executing on the social network application 122 can enable a user to access the profile of the broadcasting user so that the user can explore the contents of the profile. For example, a user can select Jane’s live streaming 402a and choose to view Jane’s profile information, e.g., name, age, and biographical text as shown in FIG. 4B, join Jane’s live streaming, or both. In some implementations, the user can join explore Jane’s profile information while concurrently accessing Jane’s live streaming.

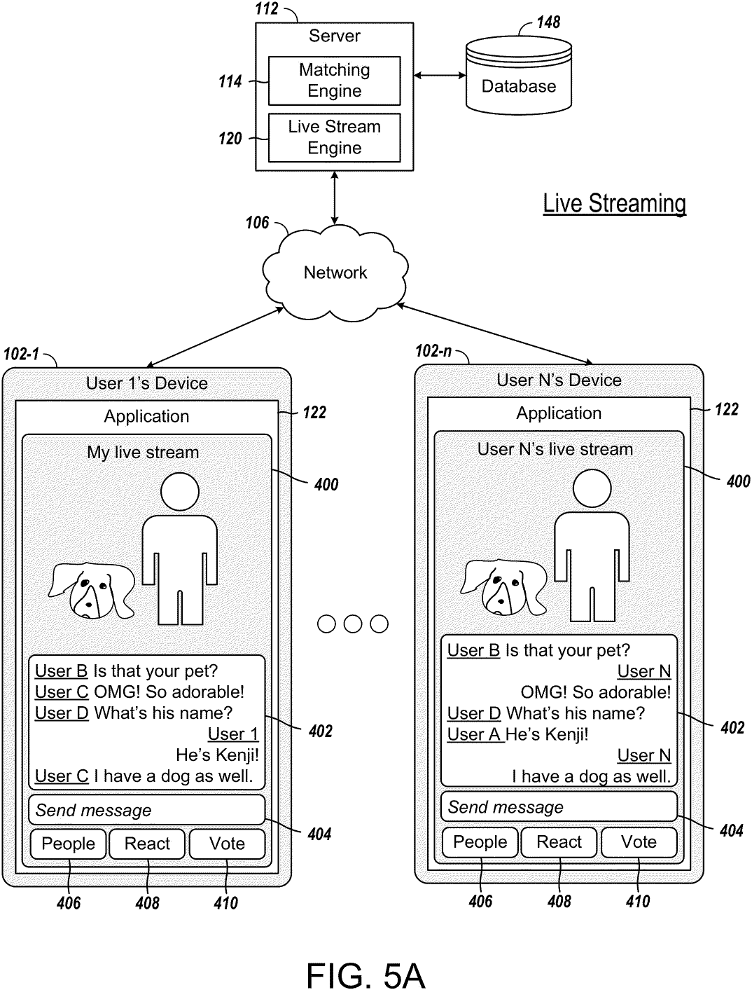

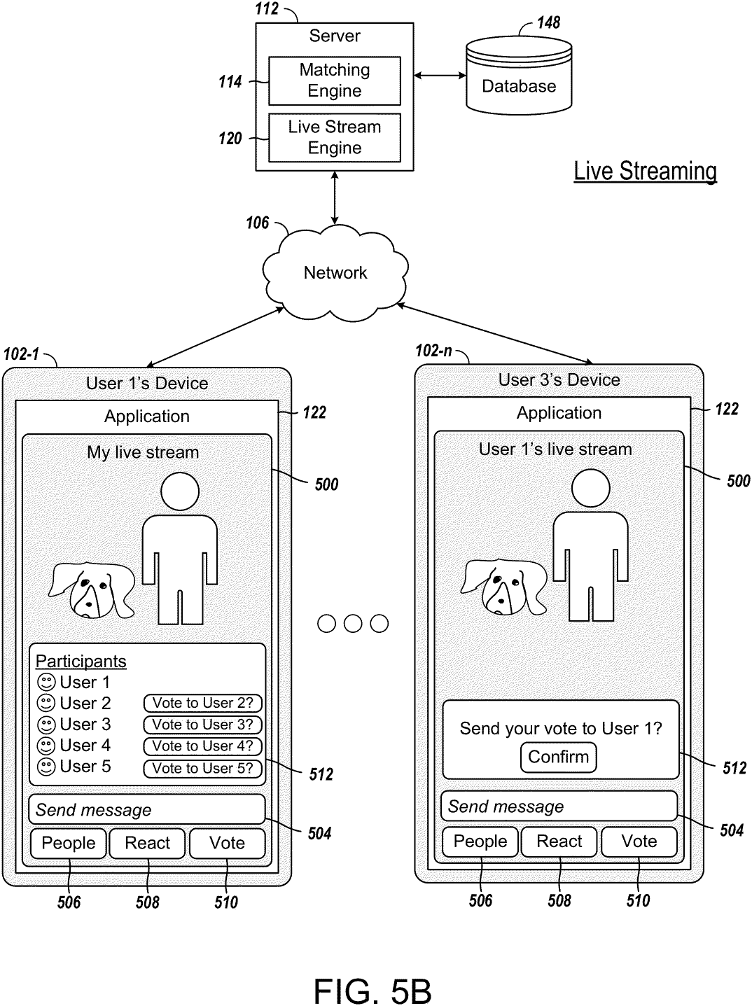

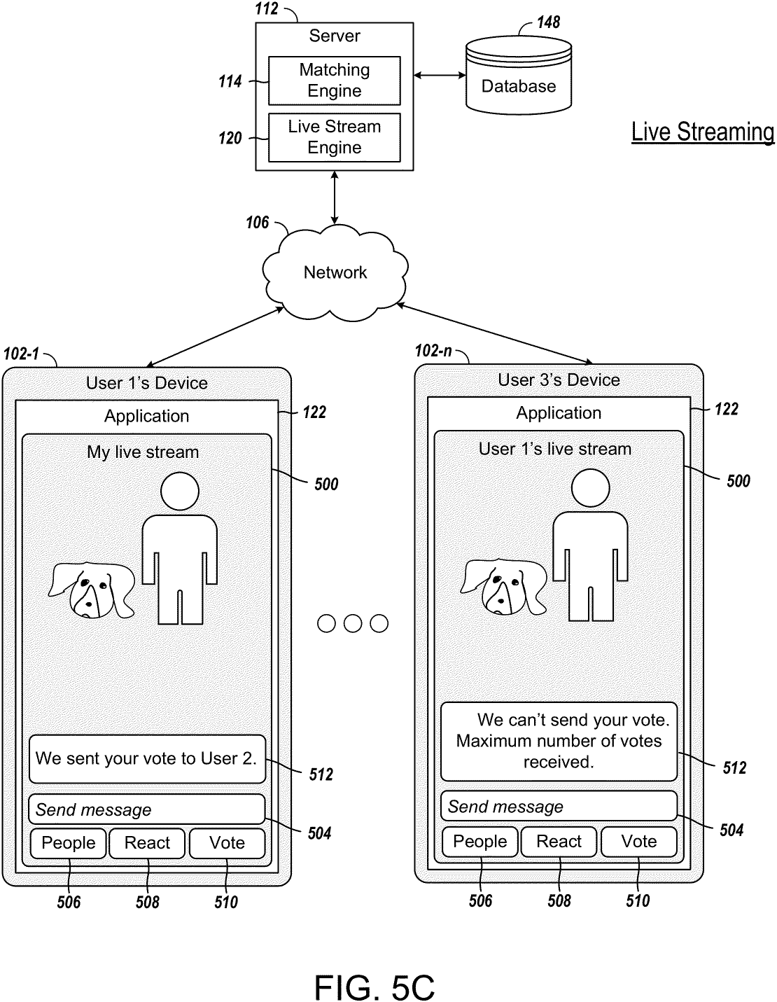

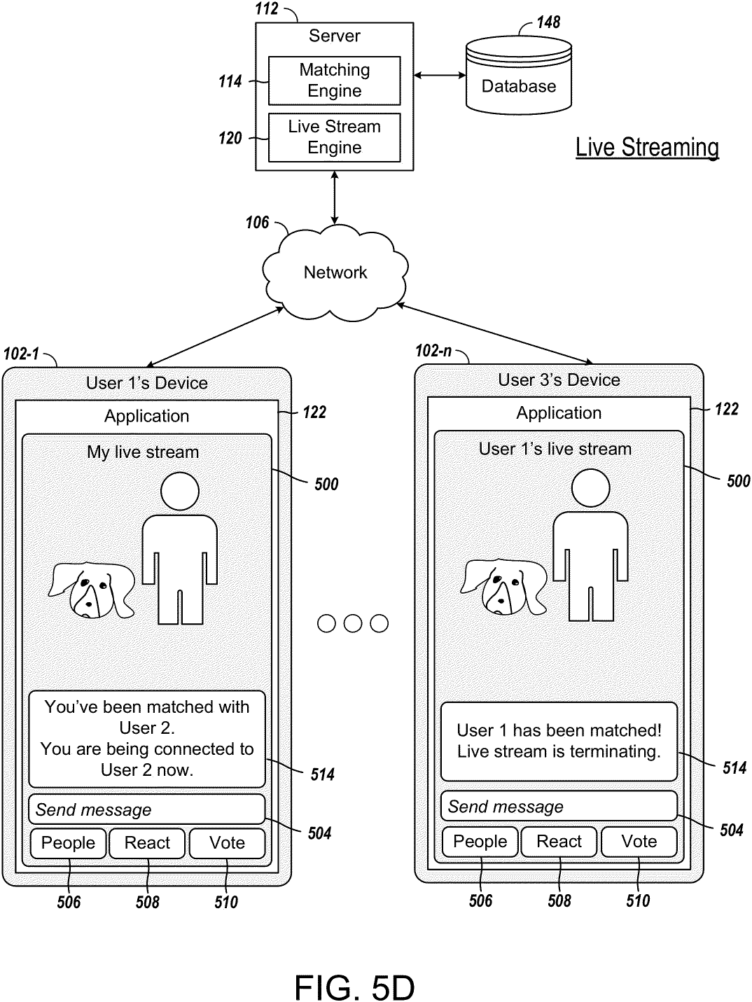

FIG. 5A is a block diagram that illustrates an example of a user interface for live streaming functions. In this example, the broadcasting user’s device 102-1 is broadcasting a live streaming to the server 112 via the network 106. One or more viewing users can join the broadcasting user’s live streaming using their respective client devices, e.g., the client device 102-n. As described above, the live streaming is open to users who request to join. In some implementations, the broadcasting user can set one or more privacy settings, e.g., certain geography, certain age or gender, to specify which users can join his or her live streaming. A live stream interface 500 executing on the application 122 displays the broadcasting user’s live streaming. For example, the live stream interface 500 broadcasts the audio and video data of the live streaming of User A along with User A’s dog Kenji to all viewing users that are present in User A’s live streaming. In some implementations, the live stream interface for the broadcasting user and the live stream interface for the viewing users are different; for example, the live stream interface for the broadcasting user can display additional features (e.g., the ability to remove a viewing user from the live streaming) to the broadcasting user. In some implementations, the live stream interface 500 includes a chat window 502, where both the broadcasting user and the viewing users can see messages communicated in a particular live streaming. For example, User A is the broadcasting user of the live streaming, and Users B, C, and D are viewing users of User A’s live streaming. Each user can send messages either to all users present in User A’s live streaming or to designated user(s) through a send message box 504. The live stream interface 500 can include a people selectable element 506 that allows each user to see which users are present in the live streaming, a react selectable element 508 that allows each user to send reactions, e.g., like, laugh, etc., and a vote selectable element 510 that allows each viewing user to vote to match with the broadcasting user, e.g., User A, and allows the broadcasting user to vote to match with one or more of viewing users. In some implementations, the people selectable element 506 enables users to explore other users’ profile information, e.g., as illustrated in FIG. 4B.

FIG. 5B is another block diagram that illustrates an example of a user interface for live streaming functions. In particular, FIG. 5B illustrates an example vote interface 512. As described above, the voting can be bidirectional, by both the broadcasting user, e.g., User A, and one or more viewing users, e.g., User C, who are participating the broadcasting user’s live streaming. The live stream interface 500 enables display of the vote interface 512 to the client device, and the user interacts with the vote selectable element 510 via the vote interface 512. For example, when the viewing user, e.g., User C, selects the vote selectable element 510 to match with the broadcasting user, e.g., User A, the application 122 displays the vote interface 512 to ask the viewing user to confirm the vote. In some implementations, the viewing user can vote to match with the broadcasting user by swiping, e.g., clicking and dragging the live stream interface 500 using fingers, off the screen in a certain direction, e.g., right. Similarly, the broadcasting user, e.g., User A, can vote to match with one or more viewing users of the live streaming by interacting with the vote interface 512. The vote interface 512 can populate and provide a list of users to be voted on by the broadcasting user. For example, the system 100 can apply filtering or criteria to populate which users the broadcasting user can vote for, e.g., restricting to a particular gender, interest, or age group, among others. Alternatively, the vote interface 512 can populate a list of users who already voted to match with the broadcasting user. In some implementations, the broadcasting user can click the people selectable element 506, or swipe in a certain direction, to send vote(s) to match (or not match) with one or more viewing users. During the process of sending vote(s), the system 100 continues to broadcast the live streaming through the live stream interface 500.

Referring to FIG. 5C, the system 100 can identify a number of viewing users who voted to match with the broadcasting user and determine whether the number of viewing users who voted to match with the broadcasting user exceeds a pre-defined threshold of a maximum number of votes to be received by the broadcasting user. For example, when the maximum number of votes is set as two votes, e.g., either by the broadcasting user or by the system, and when the broadcasting user, e.g., User A, already received two votes, the vote interface 512 displays a warning message to the viewing user’s client device 102-n, e.g., “We can’t send your vote. Maximum number of votes received”, as shown in FIG. 5C. In some implementations, when the number of users who voted to match with the broadcasting user exceeds the pre-defined threshold, the application 122 displays the stream interface 500 without presenting the vote selectable element 510, allowing viewing users to participate in the live streaming without the ability to vote.

Referring to FIG. 5D, the live stream interface 500 displays a matching outcome through a match message interface 514, once the matching engine 114 determines if two users, one of whom is a broadcasting user of the live streaming, both mutually voted ‘yes.’ When the matching engine 114 identifies a mutual vote (sometimes referred to as a “match”), the match message interface 514 can supply a notification of the match outcome to both the broadcasting user and the viewing users. For example, the match message interface 514 notifies the viewing user, e.g., User C, that “User A has been matched!” To the broadcasting user, the match message interface 514 notifies whom the broadcasting user is matched with, e.g., “You’ve been matched with User B.” The match message interface 514 can further display the message that the live streaming is terminating, and for two matched users, an additional message that they are being connected to each other via a one-to-one communication channel.

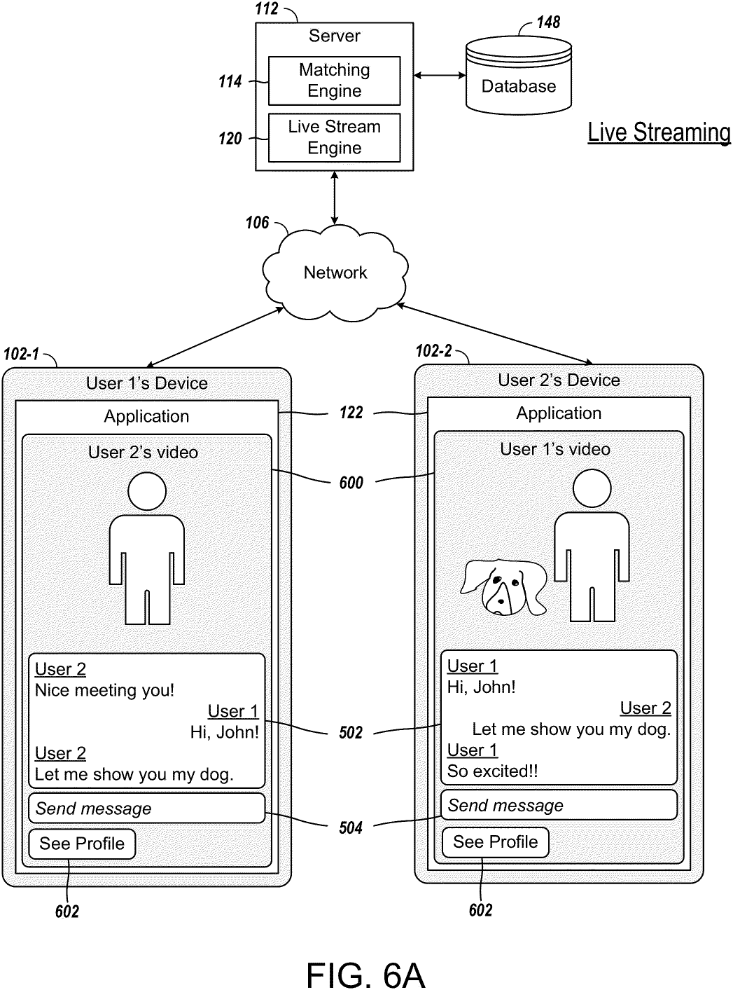

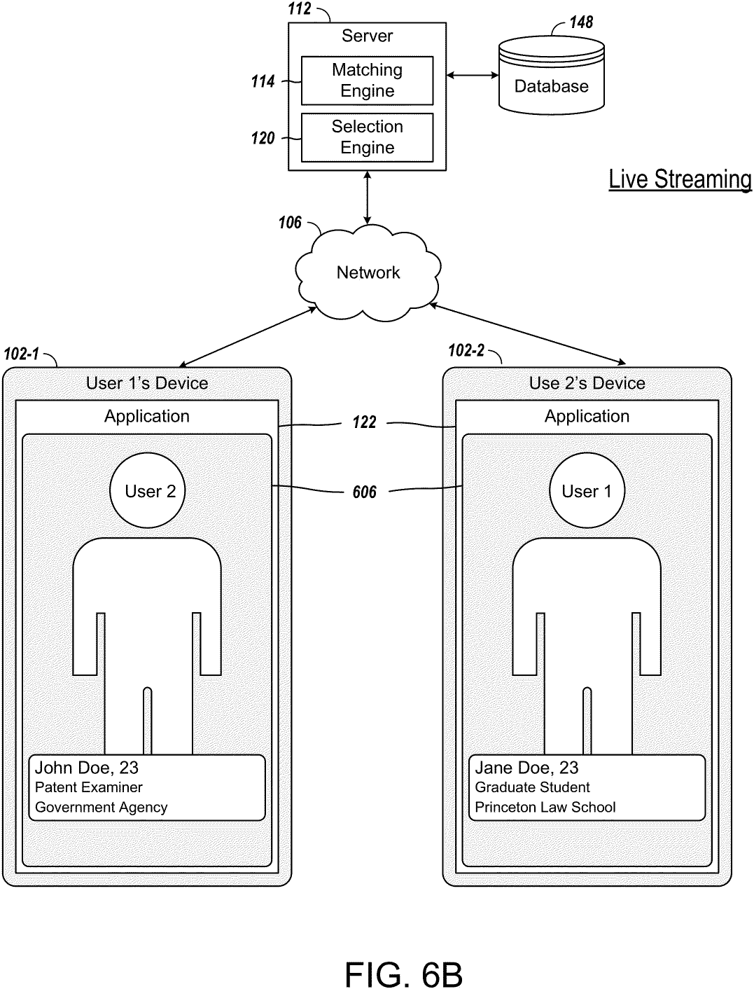

FIG. 6A is a block diagram that illustrates an example of a system for users communicating within a live streaming function. In particular, FIG. 6A illustrates an example one-to the broadcasting user, e.g., User A using a client device 102-1, and the viewing user, e.g., User 2 using a client device 102-2. The broadcasting user and the viewing user have been matched from the broadcasting user’s live streaming. The system 100 enables the one-to-one live streaming between the broadcasting user and the viewing user, immediately after terminating the broadcasting user’s live streaming. For example, the live communication interface 600 enables the one-to-one live streaming or live communications, e.g., by transmitting audio or/and video data from 102-1 and 102-2 to the server, between two users who have been matched to each other. The one-to-one communication can be a combination of one or more of the audio, video, and message data. For example, the one-to-one live communication interface 600 can include message data, e.g., via the chat window 502 where the broadcasting user and the viewing user can send messages using the send message box 504.

The system 100 can provide a feature that allows matched users to see each other’s profile via a profile selectable element 602. Referring to FIG. 6B, the application 122 can present the matched user’s profile information through the user interface 606, in response to the user’s selection of the profile selectable element 602. In some implementations, in response to the user’s selection of the other user’s name in the chat window 502 as shown in FIG. 6A, the application 122 can present the matched user’s profile information through the user interface 606 as shown in FIG. 6B. As described above, the user interface 606 can include profile information, such as name, age, biographical text, photographs, and a range of other fields (e.g., city, links to social media profiles on other networks, etc.).

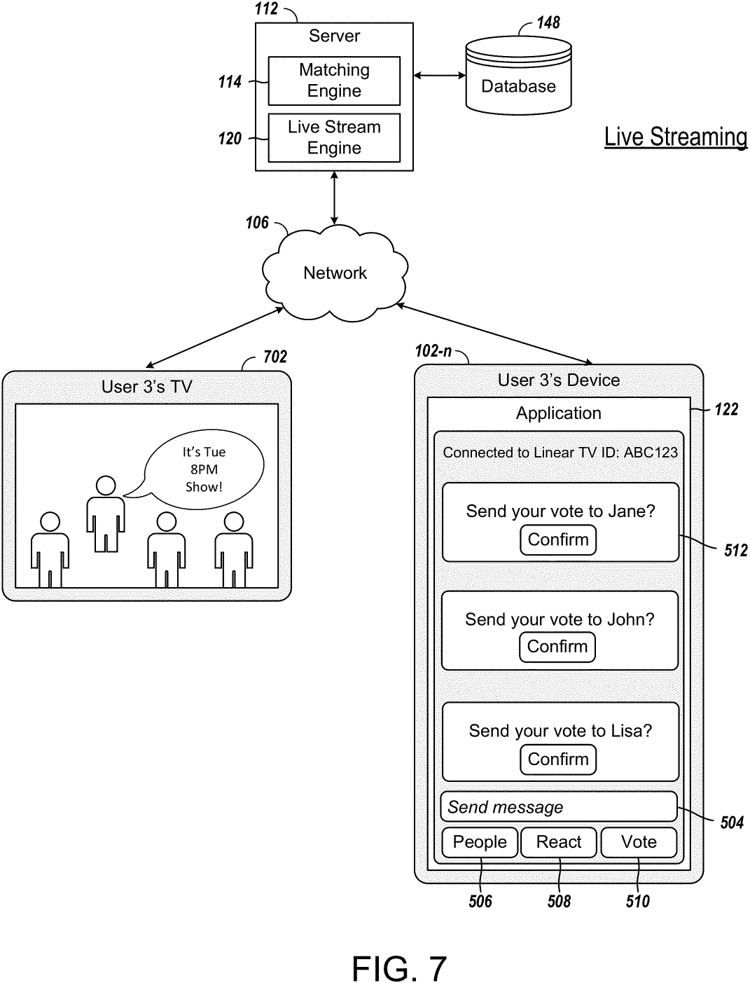

FIG. 7 is a block diagram that illustrates an example of a user interface for a discovery channel in a live streaming function. In particular, FIG. 7 illustrates the live streaming based discovery channel being presented on a display 702. The system 100 can present the discovery channel on the display 702 using a linear channel, e.g., linear TV. The discovery channel broadcasted on the linear channel can include a live streaming hosted by a single user or by multiple users. While the system 100 broadcasts the live streaming to the display 702 via the network 106, the client device 102-n displays the application 122. In some implementations, the application 122 obtains the user input of the live streaming identification, e.g., “ABC123” shown in FIG. 7, to connect with a particular live streaming broadcasted on a linear TV. The application 122 can present the vote interface 512 to the client device 102-n. In some implementations, the vote interface 512 displays an option to vote for multiple broadcasting users, in the case that more than one user hosts the live streaming. In some implementations, the viewing user can vote to match with the broadcasting user by interacting with (e.g., clicking) the vote selectable element 510. The broadcasting user of the live streaming can vote to match with one or more viewing users using the application 122. As described above, the system 100 can determine a mutual vote between two users, terminate a live streaming, and establishes a one-to-one live communication between two users who have been matched. As shown previously in FIG. 6A, the system 100 enables the one-to-one live communications between two matched users. In some implementations, the one-to-one live communication between matched users is through their client devices (e.g., mobile devices). In some implementations, the one-to-one live communication between matched users is through the linear channel.

The system 100 can identify a live streaming that includes a forbidden content topic. Examples of forbidden content topics include verbal assault, violence, assault, and sexual violence. In some implementations, the live stream engine 120 accesses the audio and video streams of live communications and can generate a report if the live stream engine 120 detects a live streaming that includes forbidden content topic(s). In some implementations, viewing users can report a particular live streaming that involves a forbidden content topic by selecting a user selectable report element (not illustrated) in the live stream interface 500. In response to the user’s selection of report element, the user can specify a forbidden content topic and attach a supporting document, e.g., screenshot of the live streaming. The live stream engine 120 then receives the user’s report and determines, based on the supporting document or the audio/video data of the live streaming, if the particular live streaming indeed includes a forbidden content topic. In some implementations, the live stream engine 120 includes a machine learning model that is trained to identify a live streaming with a forbidden content topic; training the model is based on a set of training data and a ground-truth label specifying (i) a set of live communications with a forbidden content topic and (ii) a set of live communications without a forbidden content topic. The live stream engine 120 uses the model to identify the live streaming that is predicted to include a forbidden content topic. Upon identifying the live streaming that includes a forbidden content topic, the system 100 can terminate such live streaming. For example, the application 122 will terminate the live stream interface 500 and stop transmitting the live stream data to the server 112 and to the client devices of the viewing users.

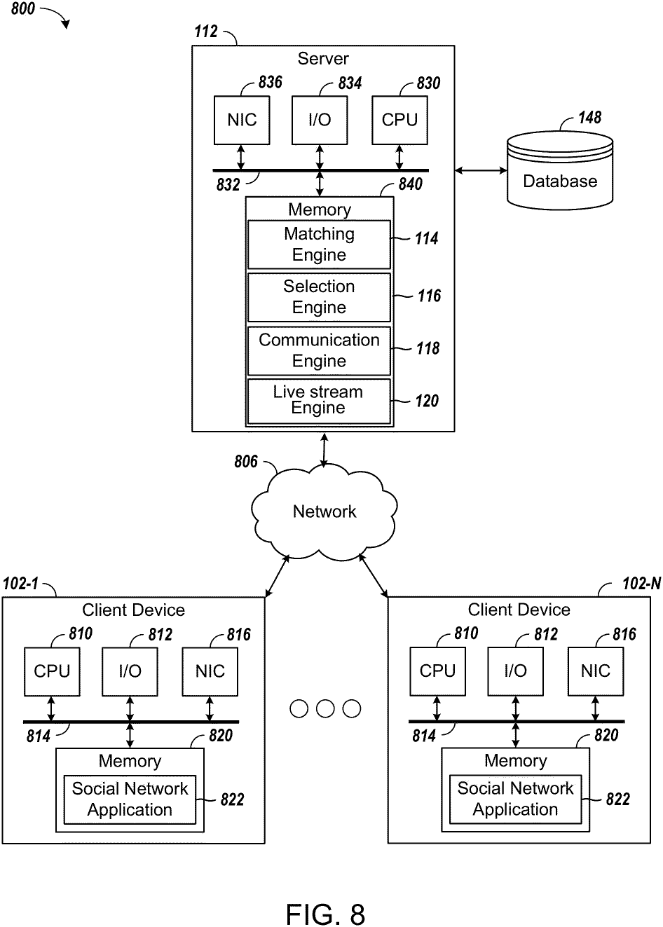

FIG. 8 is a block diagram that illustrates an example of a system in a social networking environment. In some implementations, the system 800 can include a plurality of client devices 102-1 through 102-N in communication with a server 112 via a network 106. The network 806 can include a wired, wireless network, or any combination thereof. For example, the network 806 can include a connection over the Internet, a Wi-Fi connection, a Bluetooth connection, or some other local or extranet connection.

Each of the client devices 102-1 through 102-N, e.g., referred to as “client devices 102,” can include one or more processors, e.g., a central processing unit, 810 in communication with input/output devices 812 via a communication bus 814. The input/output devices 812 can include, for example, a touch display, a keyboard, a mouse, a combination of the above, or another means to interact with the client devices 102. The network interface circuit (NIC) 816 can connect to the communication bus 814 to provide wired and/or wireless connectivity to the network 806. A memory or other storage medium 820 is also connected to the communication bus 814. The memory 820 for each client device stores instructions executed by the processor 810. In particular, the memory 820 stores instructions for a social network application 822, such as a social dating application or another application that is relevant to dating, professional recruiting and networking, and interest-based discussion, which communicates with the server 112 for coordinating introductions between users that have been identified as potential matches, e.g., potential friends, dating partners, business partners, etc.

In some implementations, each client device 102 can be a mobile device. The client devices 102 can be, for example, a smart phone, a laptop, a tablet, a personal computer, a handheld device, a wearable device, or some other device. The client devices 102 can execute the social network application 822 stored in memory 820. Different users that subscribe to the same social network application can operate different client devices.

In some implementations, the server 112 can include one or more components for executing the social network application. For example, the server 112 can include one or more processors 830, a communication bus 832, input/output devices 834, a network interface card (NIC) 836, and memory 840, among other components. The memory 840 can connect to the communication bus 832. Additionally, the memory 840 can store a matching engine 114, a selection engine 116, a communication engine 118, and a live stream engine 120. Each of the matching engine 114, the selection engine 116, the communication engine 118, and the live stream engine 120 can include instructions to be executed by the processor 830 to implement the processes and functions with respect to the disclosure and FIGS. 1-7 discussed above.

The live stream engine 120 enables broadcasting of live communications, referred to as “live streams,” by users. The live communications include one or more of audio data and video data. For example, users can record themselves using a camera of their respective client devices 102-1-102-N and broadcast to other users in real time or near-real time (sometimes referred to as “live”) through the social network application. The live stream engine 120 that performs operations related to broadcasting the live communications is described with respect to FIGS. 1-7.

In some implementations, the system 800 includes a database 148 in communication with the server 112. The database 148 can include, for example, one or more data storage components for storing information associated with the social network application 822. Additionally, the database 148 can store information associated with the matching engine 114, the selection engine 116, the communication engine 118, and the live stream engine 120. For example, the database 148 can store information that describes each of the client devices 102, the user profiles associated with the client devices, historical matching information between user profiles, messaging information detailing messages between matched users, virtual lobby information for both the speed dating and the singles evening functions, and other information.

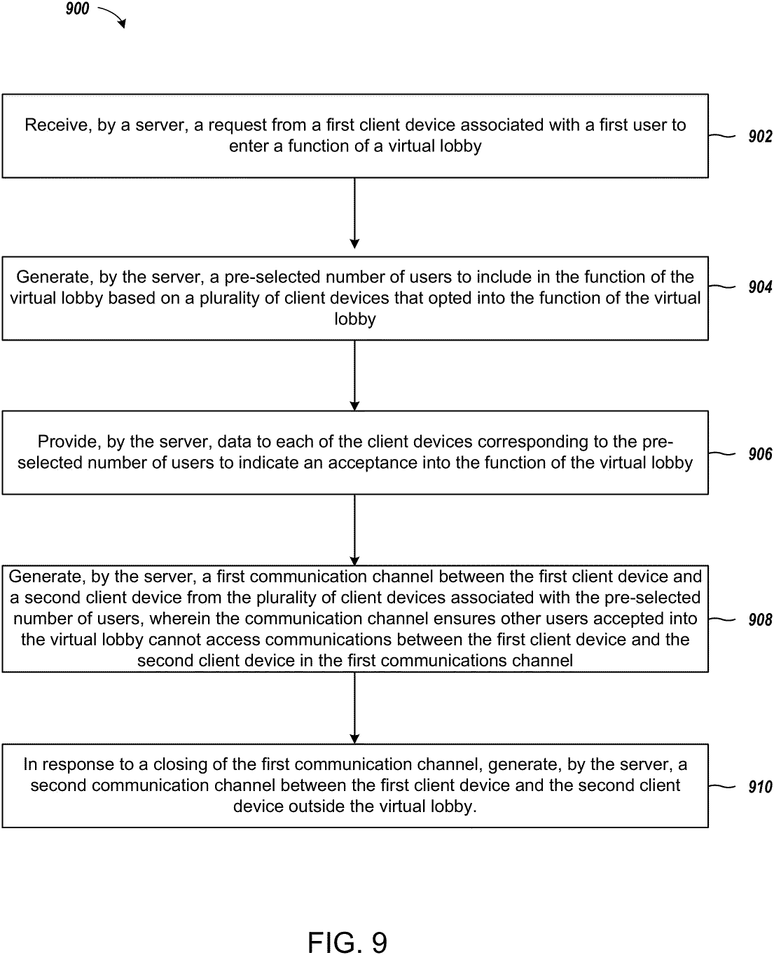

FIG. 9 is a flow diagram that illustrates an example of a process 900 for matching individuals in a social networking environment. The server 112 from the system 100 of FIG. 1 can perform the process 900, for example. In some implementations, the process 900 provides functionality related to the speed dating audio and the singles evening, which can be performed in parallel, in combination, in loops, or in any order.

The system receives a request from a first client device associated with a first user to enter a function of a virtual lobby (902). The virtual lobby can offer enhanced social experiences of the social media application for a user to create one or more matches. The virtual lobby functions can include, for example, a speed dating audio, a singles evening, and a live streaming. The user can access one or more of the functions of the virtual lobby by interacting with the display of their respective client device and selecting the function of the virtual lobby, e.g., tapping a button, speaking a command, or touching a portion of a screen corresponding to a function of the virtual lobby, to name a few examples. The client device can send a request to the system to use the specified function.

The system can receive the request from the user to access the specific function. In some implementations, the system can receive a large number of requests from a subset of client devices requesting to use a particular function in the virtual lobby. The number of requests can include 100 s, 1000 s, and larger from client devices seeking to access the function within the virtual lobby of the social networking application.

The system generates a pre-selected number of users to include in the function of the virtual lobby based on a plurality of client devices that opted into the function of the virtual lobby (904). After the system receives the requests, the system can generate groups for each of the respected requests. For example, based on the multiple requests received, the system can generate groups dictated by the type of request. The system can generate a first group from the plurality of client devices that sent requests to enter a first virtual lobby of the speed dating audio function. The system can generate a second group from the plurality of client devices that sent requests to enter a second virtual lobby of the singles evening function. In addition, the system can generate a third group from the plurality of client devices that sent requests to enter a third virtual lobby of the live streaming function. Each of the first, second, and third groups include different users.

Additionally, the system can cluster each of the groups into smaller groups. For example, the system can cluster the first group into one to N groups, where N can be any number based on characteristics of the group. The characteristics can correspond to criteria for each of the users in the clustered group, e.g., location, interests, likes, dislikes, among others. Additionally, the system can cluster the second and third groups into one to N groups, in a similar manner as described above. Once clustered (or not), the system can generate data to provide to each of these individuals in the clustered groups for interacting within each of the functions of the virtual lobby.

The system provides data to each of the client devices corresponding to the pre-selected number of users to indicate an acceptance into the function of the virtual lobby (906). For example, the system can provide first data to each of the client devices associated with the first group indicating the acceptance into the first virtual lobby of the speed dating audio function. The system can provide second data to each of the client devices associated with the second group indicating the acceptance into the second virtual lobby of the singles evening function. The system can also provide third data to each of the client devices associated with the third group indicating the acceptance into the third virtual lobby of the live streaming function. Additionally, the system can provide first data to one or more clustered groups from the first group; second data to one or more clustered groups from the second group; and, third data to one or more clustered groups from the third group.

The first data can correspond to the user interfaces and functionality required for the speed dating audio function within the social networking application. The second data can correspond to the user interfaces and functionality required for the singles evening function within the social networking application. The third data can correspond to the user interfaces and functionality required for the live streaming function within the social networking application. For example, each data, e.g., first, second, and third, can include APIs, programs to store in memory, networking data, images, software, and other execution data relative to the client device executing the particular corresponding virtual lobby function. In this manner, these client devices can execute the virtual lobby functions and communicate with the server during the implementation of the virtual lobby function.

The system can generate a first communication channel between the first client device and a second client device from the plurality of client devices associated with the pre-selected number of users, wherein the communication channel ensures other users accepted into the virtual lobby cannot access communications between the first client device and the second client device in the first communications channel (908). In particular, the system can generate the first communication channel between the first client device and the second client device from the plurality of client devices in the speed dating audio function, wherein the first communication channel is assigned based on a random match between the first client device and the second client device. For example, the first communication channel may be a line of communication between the first client device and the second client device over the server so the two client devices can send audio communications back and forth. In this case, the system can receive communications, e.g., audio communications, from the first client device through the first communication channel. In response to receiving the audio communications from the first client device, the server can provide the audio communications from the first client device through the first communication channel to the second client device. Additionally, when the first user requests to communicate with the second client device, the server can provide the request from the first client device to communicate with the second client device to the second client device. If the second client device accepts the request from the first client device, the second client device can provide the acceptance to the server over the first communications channel.

In some cases, the server can generate audible annotations from the audio communications received from the first client device. The audible annotations can include, for example, emoji’s, pictures, voices spoken by avatars, and other emotions that represent a context of the spoken words. The server can provide the audio communications and the audible annotations to the second client device over the first communication channel. Similarly, when the second client device responds to the server with audio communications, the server can generate audible annotations of the audio communications received from the second client device, and provide the audio communications and the audible annotations to the first client device over the first communication channel. This process can continue until a timer associated with the first communication channel has elapsed. When the timer elapses, the server can close the first communications channel. At this point, the two users can decide to continue the conversation in a different private channel or cease the conversation and return to the virtual lobby or return to regular matchmaking.

In some implementations, when the two users request to communicate with one another during the virtual lobby, the server generates the first communication channel to include various characteristics. The server generates these characteristics that include and ensure (i) the other users accepted into the virtual lobby cannot access subsequent communications between the first client device and the second client device for a predefined period of time and (ii) the first client device and the second client device have access to other subsequent communications between other client devices within the virtual lobby while the respective users are accessing the virtual lobby. In this case, such as during the singles evening function, the two users can (i) hear and view each other’s conversation, (ii) the outside users cannot hear the two users’ conversation, and (iii) the two users can hear the outside users’ conversations who are not communicating over their own communication channel. If the other users communicate within the virtual lobby, the two users in the private conversation, e.g., the first communications channel, can hear the communications of the other users.

In some implementations, when the server generates the first communication channel, the first communications channel enable a first user associated with the first client device and a second user associated with the second client device can communicate within a private audio conversation. The first user and the second user can hear audio conversation from other users associated with the other client devices within the virtual lobby at a low-level volume. Additionally, the other users cannot hear the private audio conversation between the first user and the second user.

In response to the closing of the first communication channel after an amount of time has elapsed during communications of the first communication channel, the server can generate second communication channel between the first client device and a third client device from the plurality of client devices in the speed dating audio function. For example, the first communication channel will close when a timer associated with the channel has elapsed. At that point, the two users associated with the first and second client device can decide whether to carry on the conversation outside the first communication channel or end conversation and return to the virtual lobby. If the users decide to carry on the conversation, both users can send a request to the system to open a second communications channel to continue the conversation. The second communications channel can correspond to a private communication channel without an elapsed timer and enable the two users to communicate with no time limit. Alternatively, the two users may decide not to continue their conversation and both proceed to access other functions or the same functions within the virtual lobby to meet different matches.

In response to a closing of the first communication channel, the system can generate a second communication channel between the first client device and the second client device outside the virtual lobby (910). The system can receive a request from the second client device that the first and second client devices request to continue a conversation outside the virtual lobby. Then, the system can generate a second communication channel between the first client device and the second client device outside the function of the virtual lobby. The second communication channel is different from the first communication channel in that no elapsed timer exists and the second communication channel enables the first and second users to communicate via audio, text, audible annotations, video, or some other form of communications.

In some implementations, the system can receive a request from a first client device associated with a first user to enter a speed dating function of a virtual lobby. The system can generate a pre-selected number of users to include in the speed dating function of the virtual lobby based on a plurality of client devices that opted into the speed dating function of the virtual lobby. The system can provide data to each of the client devices corresponding to the pre-selected number of users to indicate an acceptance into the speed dating function of the virtual lobby. The system can generate a first communication channel between the first client device and a second client device from the plurality of client devices associated with the pre-selected number of users, wherein the generated first communication channel is based on shared similarities between the first user and a second user associated with the second client device. The system can manage communications over the first communication channel between the first client device and the second client device for a predetermined amount of time. In response to the predetermine amount of time elapsing, the system can close the first communications channel. The system can generate a second communication channel between the first client device and a third client device from the plurality of client device associated with the pre-selected number of users.

In some implementations, the system can receive a request from a first client device associated with a first user to enter a singles evening function of a virtual lobby. The system can generate a pre-selected number of users to include in the singles evening function of the virtual lobby based on a plurality of client devices that opted into the singles evening function of the virtual lobby. The system can provide data to each of the client devices corresponding to the pre-selected number of users to indicate an acceptance into the singles evening function of the virtual lobby. The system can receive a whisper request from the first client device, the whisper request indicating a request to open a communications channel between the first client device and a second client device. The system can provide the whisper request to the second client device. The system can receive an acceptance from the second client device to initiate the whisper request. In response to receiving the acceptance, the system can generate a first communications channel between the first client device and the second client device. The system can also manage first communications over the first communications channel between the first client device and the second client device, wherein the first communications channel enables (i) the first client device and the second client device to access second communications within the virtual lobby from other client devices, (ii) the first client device and the second client device can access the first communications, and (iii) blocks the other client devices within the virtual lobby from accessing the first communications.

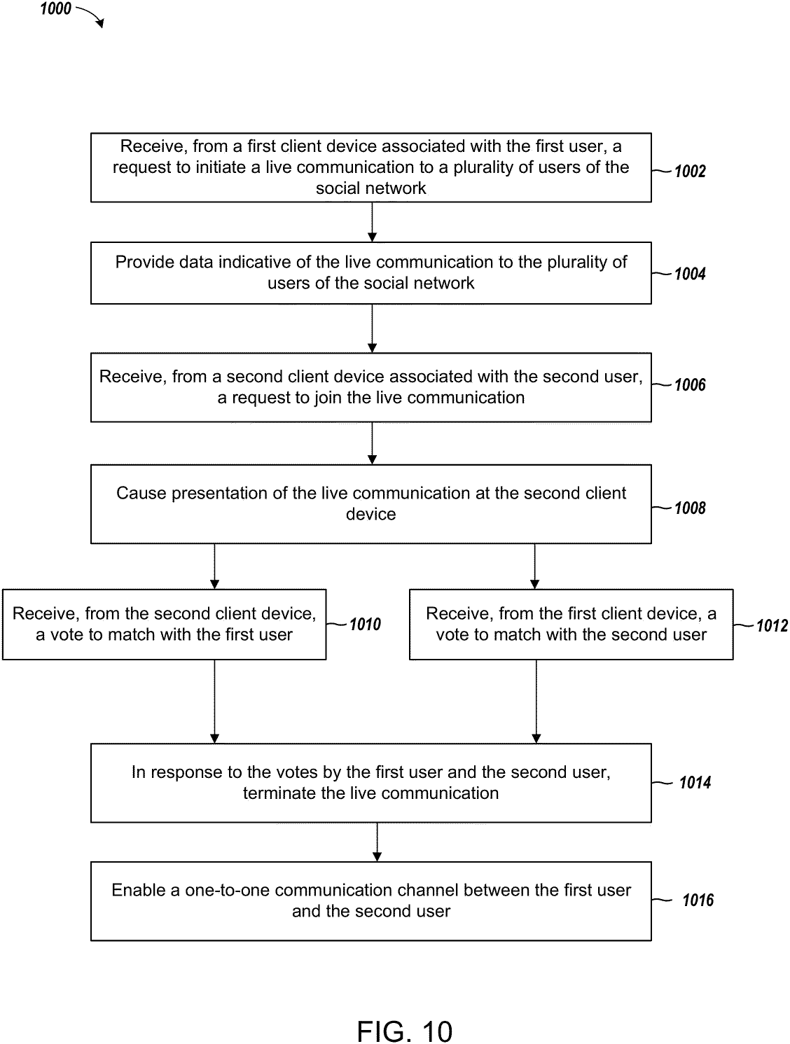

FIG. 10 is a flowchart of an example process 1000 for identifying a potential match between a first user and a second user through the live streaming-based discovery channel. The process 1000 will be described as being performed by a system of one or more computers programmed appropriately in accordance with this specification. For example, the live stream engine 120 from the system 100 of FIG. 1 can perform at least a portion of the example process. In some implementations, the process 1000 provides a live streaming based discovery channel, which can be performed in parallel, in combination, in loops, or in any order.

The system receives, from a first client device associated with the first user, a request to initiate a live streaming to a plurality of users of the social network (1002). The users of the social network can be users from the social network application 122. For example, the first user can request to initiate a live streaming by selecting the go live button from the live stream feed executing on the application 122 (see FIG. 4A). In some implementations, the application 122 prompts the first user to select the source of audio and video and further prompts the first user to indicate whether he or she would like to use audio or video only.

The system provides data indicative of the live communication to users of the social network, in response to the request to initiate the live communication (1004). For example, the server receives data indicative of the live communication or live streaming, e.g., audio and/or video data from the first user’s client device, through the network. Then, the server transmits data indicative of the live streaming to users of the social network so that the first user’s live streaming is discoverable by the other users, e.g., through the live stream feed.

The system receives, from a second client device associated with the second user, a request to join the live communication (1006). For example, the second user can navigate through displayed available live communications, e.g., 402a-402d. In some implementations, the system 100 displays one live streaming at a time, and the second user interacts with a user interface button or swipe the screen to view each live streaming, e.g., display live communication 402a first, then when the second user swipes left, display live communication 402b next. As described above, in some implementations, the application 122 displays live streams chronologically, based on time of initiation. In some implementations, the application 122 displays live streams based on the second user’s interests. The second user can select the live streaming he or she would like to join by selecting the desired live streaming component, e.g., by clicking on 402a.

The system causes presentation of the live communication at the second client device, in response to the request to join the live communication (1008). For example, the system displays the first user’s live streaming to the live stream interface 400. The live stream user interface 400 allows both the first user and other participating users of the first user’s live streaming to access the live communication, e.g., message, audio, and/or video data by the first user.

The system receives, from the second client device, a vote to match with the first user (1010). As described above, the voting is bidirectional. For example, the system can present the vote interface 512 that allows the participating users to send a vote to match with the first user.

The system receives, from the first client device, a vote to match with the second user (1012). For example, the vote interface 512 allows the first user to send a vote to match with one or more participating users.

In response to the votes by the first user and the second user, the system terminates the live communication (1014). For example, the matching engine 114 can identify a mutual vote, e.g., also referred as a match, between the first user and one of the participating users, e.g., the second user, of the first user’s live streaming. Upon identifying a mutual vote, the system terminates the live streaming. For example, the system can stop transmitting the live communication data from the server to the client devices. The match message interface 514 displays a matching outcome to the first user and all the other participating users of the first user’s live streaming. In addition, the match message interface 514 displays a message, to two matched users, that they are being directed to a one-to-one communication channel.

The system enables a one-to-one communication channel between the first user and the second user (1016). For example, the system enables transmission of one or more of audio data, video data, and message data between the first client device, e.g., 102-1; FIG. 6A, and the second client device, e.g., 102-2; FIG. 6A. The transmission of the audio, video, and/or message data is through the network 106, as the system transmits data acquired from the client devices to the server 112.

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer-readable medium for execution by, or to control the operation of, data processing apparatus. The computer readable medium may be a non-transitory computer readable storage medium, a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the invention may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the invention may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the invention, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a server, a request from a first client device associated with a first user to enter a function of a virtual lobby;
generating, by the server, a pre-selected number of users to include in the function of the virtual lobby based on a plurality of client devices that opted into the function of the virtual lobby;
providing, by the server, data to each of the client devices corresponding to the pre-selected number of users to indicate an acceptance into the function of the virtual lobby;
generating, by a the server, a first communication channel between the first client device and a second client device from the plurality of client devices associated with the pre-selected number of users, wherein the communication channel ensures other users accepted into the virtual lobby cannot access communications between the first client device and the second client device in the first communications channel; and
in response to a closing of the first communication channel, generating, by the server, a second communication channel between the first client device and the second client device outside the virtual lobby.

2. The computer-implemented method of claim 1, wherein the function of the virtual lobby comprises one or more of (i) a speed dating audio function, (ii) a singles evening function, or (iii) a live streaming function.

3. The computer-implemented method of claim 2, wherein generating the pre-selected number of users to include in the function of the virtual lobby based on the plurality of client devices that opted into the function of the virtual lobby further comprises:
receiving, by the server, multiple requests from the plurality of client devices to enter the speed dating audio function, the singles evening function, or the live streaming function;
generating, by the server, a first group from the plurality of client devices to enter a first virtual lobby of the speed dating audio function;
generating, by the server, a second group from the plurality of client devices to enter a second virtual lobby of the singles evening function; and
generating, by the server, a third group from the plurality of client devices to enter a third virtual lobby of the live streaming function, wherein the users associated with the first group, the users associated with the second group, and the users associated with the third group are each different.

4. The computer-implemented method of claim 3, further comprising:
generating, by the server, (i) one or more clusters within the first group, (ii) one or more clusters within the second group, and (iii) one or more clusters within the third group, wherein the server generates the one or more clusters for each group based on criteria associated with each of the clusters.

5. The computer-implemented method of claim 3, wherein providing the data to each of the client devices corresponding to the pre-selected numbers to indicate the acceptance into the function of the virtual lobby further comprises:
providing, by the server, first data to each of the client devices associated with the first group indicating the acceptance into the first virtual lobby of the speed dating audio function;
providing, by the server, second data to each of the client devices associated with the second group indicating the acceptance into the second virtual lobby of the singles evening function; and
providing, by the server, third data to each of the client devices associated with the third group indicating the acceptance into the third virtual lobby of the live streaming function.

6. The computer-implemented method of claim 1, wherein generating the first communication channel between the first client device and a second client device from the plurality of client devices associated with the pre-selected number of users further comprises:
generating, by the server, the first communication channel between the first client device and the second client device from the plurality of client devices in the speed dating audio function, wherein the first communication channel is assigned based on a random match between the first client device and the second client device; and
in response to the closing of the first communication channel after an amount of time has elapsed during communications of the first communication channel, generating, by the server, a second communication channel between the first client device and a third client device from the plurality of client devices in the speed dating audio function.

7. The computer-implemented method of claim 6, wherein the first user associated with the first client device and a second user of the second client device communicate over the first communication channel using audio communications, the method further comprises:
receiving, by the server, the audio communications from the first client device through the first communication channel; and
providing, by the server, the audio communications from the first client device through the first communication channel to the second client device.

8. The computer-implemented method of claim 7, further comprising:
in response to receiving the audio communications from the first client device, generating, by the server, audible annotations from portions of the received audio communications; and
providing, by the server, the generated audible annotations from portions of the received audio communications, to the second client device.

9. The computer-implemented method of claim 1, wherein generating the first communication channel between the first client device and a second client device from the plurality of client devices associated with the pre-selected number of users further comprises:
receiving, by the server, a request from the first client device to communicate with the second client device within the virtual lobby;
generating, by the server, the first communication channel between the first client device and the second client device within the virtual lobby, wherein the first communication channel ensures (i) the other users accepted into the virtual lobby cannot access subsequent communications between the first client device and the second client device for a predefined period of time and (ii) the first client device and the second client device have access to other subsequent communications between other client devices within the virtual lobby while the respective users are accessing the virtual lobby;
providing, by the server, the request from the first client device to communicate with the second client device to the second client device; and
receiving, by the server, an acceptance from the second client device indicating the second client device accepts the request to communicate with the first client device over the first communication channel.

10. The computer-implemented method of claim 9, wherein generating the first communication channel between the first client device and the second client device within the virtual lobby further comprises:
generating, by the server, the first communication channel between the first client device and the second client device within the virtual lobby, wherein the first user associated with the first client device and the second user associated with the second client device communicate within a private audio conversation over the first communication channel.

11. The computer-implemented method of claim 10, wherein the first user and the second user hear audio conversation from other users associated with the other client devices within the virtual lobby at a low-level volume.

12. The computer-implemented method of claim 10, wherein the other users cannot hear the private audio conversation between the first user and the second user.

13. The computer-implemented method of claim 1, wherein in response to the closing of the first communication channel, generating the second communication channel between the first client device and the second client device outside the virtual lobby further comprises:
receiving, by the server, a request from the second client device that they request to continue a conversation with the first client device out the virtual lobby; and
generating, by the server, the second communication channel between the first client device and the second client device outside the function of the virtual lobby.

14. A computer implemented method comprising:
receiving, by a server, a request from a first client device associated with a first user to enter a speed dating function of a virtual lobby;
generating, by the server, a pre-selected number of users to include in the speed dating function of the virtual lobby based on a plurality of client devices that opted into the speed dating function of the virtual lobby;
providing, by the server, data to each of the client devices corresponding to the pre-selected number of users to indicate an acceptance into the speed dating function of the virtual lobby;
generating, by the server, a first communication channel between the first client device and a second client device from the plurality of client devices associated with the pre-selected number of users, wherein the generated first communication channel is based on shared similarities between the first user and a second user associated with the second client device;
managing, by the server, communications over the first communication channel between the first client device and the second client device for a predetermined amount of time;
in response to the predetermined amount of time elapsing, closing, by the server, the first communications channel; and
generating, by the server, a second communication channel between the first client device and a third client device from the plurality of client device associated with the pre-selected number of users.

15. A computer implemented method comprising:
receiving, by a server, a request from a first client device associated with a first user to enter a singles evening function of a virtual lobby;
generating, by the server, a pre-selected number of users to include in the singles evening function of the virtual lobby based on a plurality of client devices that opted into the singles evening function of the virtual lobby;
providing, by the server, data to each of the client devices corresponding to the pre-selected number of users to indicate an acceptance into the singles evening function of the virtual lobby;
receiving, by the server, a whisper request from the first client device, the whisper request indicating a request to open a communications channel between the first client device and a second client device;
providing, by the server, the whisper request to the second client device;
receiving, by the server, an acceptance from the second client device to initiate the whisper request;
in response to receiving the acceptance, generating, by the server, a first communications channel between the first client device and the second client device; and
managing, by the server, first communications over the first communications channel between the first client device and the second client device, wherein the first communications channel enables (i) the first client device and the second client device to access second communications within the virtual lobby from other client devices, (ii) the first client device and the second client device can access the first communications, and (iii) blocks the other client devices within the virtual lobby from accessing the first communications.

16. A computer-implemented method for identifying a match between a first user and a second user, wherein the first user and the second user are users of a social network, the method comprising:
receiving, from a first client device associated with the first user, a request to initiate a live communication to a plurality of users of the social network;
in response to the request to initiate the live communication, providing data indicative of the live communication to the plurality of users of the social network, wherein the plurality of users include the second user;
receiving, from a second client device associated with the second user, a request to join the live communication;
in response to the request to join the live communication, causing presentation of the live communication at the second client device;
receiving, from the second client device, a vote to match with the first user;
receiving, from the first client device, a vote to match with the second user;
in response to the votes by the first user and the second user:
terminating the live communication; and
enabling a one-to-one communication channel between the first user and the second user.

17. The computer-implemented method of claim 16, wherein the live communication is a real time transmission from the first client device to the second client device through a server of the social network.

18. The computer-implemented method of claim 16, wherein causing presentation of the live communication comprises causing transmission of one or more of audio data and video data.

19. The computer-implemented method of claim 16, wherein providing the data indicative of the live communication comprises providing a feed of available live communications to the second client device, the feed including the live communication.

20. The computer-implemented method of claim 16, comprising:
identifying a number of users who voted to match with the first user;
determining that the number of users who voted to match with the first user exceeds a pre-defined threshold of a maximum number of votes to match with the first user; and
in response to determining that the number of users who voted to match with the first user exceeds the pre-defined threshold, causing presentation of the live communication at a client device associated with at least one of the plurality of users without an option to express a vote to match with the first user.

21. The computer-implemented method of claim 16, wherein enabling the one-to-one communication channel between the first user and the second user comprises enabling transmission of one or more of audio data and video data between the first client device and the second client device.

22. The computer-implemented method of claim 16, wherein terminating the live communication comprises enabling display indicative of information that a match is established to the first client device associated with the first user and the second client device associated with the second user.

23. The computer-implemented method of claim 16, further comprising:
determining that the live communication includes a forbidden content topic; and
terminating the live communication that includes the forbidden content topic.

24. The computer-implemented method of claim 16, wherein receiving the request to initiate the live communication comprises receiving a request from the first client device to enter a live streaming function of a virtual lobby.

25. The computer-implemented method of claim 16, wherein receiving the request to join the live communication comprises receiving a request from the second client device to enter a live streaming function of a virtual lobby.

26. The computer-implemented method of claim 19, wherein providing the feed of available live communications comprises organizing the feed of available live communications on a display of the second client device based on an initiation time of each of the available live communications.

27. The computer-implemented method of claim 19, wherein providing the feed of available live communications comprises presenting, on a display of the second client device, a subset of all available live communications, wherein the subset is selected based on one or more matching criteria associated with the first user and the second user.

28. The computer-implemented method of claim 16, further comprising:
receiving, from the second client device, a request to view content associated with a profile of the first user prior to receiving the request to join the live communication; and
in response to the request to view the content associated with the profile of the first user, causing presentation of the content associated with the profile of the first user at the second client device.

29. The computer-implemented method of claim 16, further comprising:
receiving, from the second client device, a request to view content associated with a profile of the first user subsequent to receiving the request to join the live communication; and
in response to the request to view the content associated with the profile of the first user, causing presentation of the content associated with the profile of the first user at the second client device concurrently to causing presentation of the live communication at the second client device.
